(19) United States
(12) Patent Application Publication
(10) Pub. No.: US 2015/0260325 A1
(43) Pub. Date: Sep. 17, 2015

(54) Genderless Coupling Devices

(71) Applicant: Colder Products Company, St. Paul, MN (US)

(72) Inventor: Andrew Morgan Quick, Circle Pines, MN (US)

(21) Appl. No.: 14/657,025

(22) Filed: Mar. 13, 2015

Related U.S. Application Data
(60) Provisional application No. 61/953,272, filed on Mar. 14, 2014.

(51) Int. Cl. F16L 37/26

(52) U.S. Cl. CPC F16L 37/26

(57) ABSTRACT

A coupling assembly includes: a first coupling device including: an insert configured to be coupled to a source or a destination of a fluid; a seal coupled to the insert to create a seal with a mating seal; and a sleeve coupled to the insert, the sleeve including a locking structure; and a second coupling device that is substantially identical to the first coupling device. The first coupling device is coupled to the second coupling device by rotating the second coupling device relative to the first coupling device and moving the second coupling device axially towards the first coupling device to allow the locking structure on the first coupling device to engage the locking structure on the second coupling device and seals of the first and second coupling devices to form an axial seal so that fluid can flow from the line and through the first and second coupling devices.

### BACKGROUND

Coupling assemblies can include two coupling devices that are connected to create a fluid flow path therebetween. Such coupling assemblies typically include a male coupling device and a female coupling device that are joined to form the coupling assembly. The coupling assembly can be used in various applications, including biomedical applications, beverage dispensing, instrument connections, photochemical handling, and others. When making such couplings, it can be desirable to make the connections easy to accomplish while being robust.

### SUMMARY

In one non-limiting aspect, a coupling assembly includes: a first coupling device including: an insert configured to be coupled to a source or a destination of a fluid; a seal coupled to the insert to create a seal with a mating seal; and a sleeve coupled to the insert, the sleeve including a locking structure; and a second coupling device that is substantially identical to the first coupling device; wherein the first coupling device is coupled to the second coupling device by rotating the second coupling device relative to the first coupling device and moving the second coupling device axially towards the first coupling device to allow the locking structure on the first coupling device to engage the locking structure on the second coupling device and the seals of the first and second coupling devices to form an axial seal so that fluid can flow from the tubing and through the first and second coupling devices. The insert and the sleeve can be separate or integral.

### DESCRIPTION OF THE DRAWINGS

Reference is now made to the accompanying drawings, which are not necessarily drawn to scale.

FIG. 1 is perspective view of an example coupling device.

FIG. 2 is a cross-sectional view of the coupling device of FIG. 1.

FIG. 3 is a side view of the coupling device of FIG. 1.

FIG. 4 is a front view of the coupling device of FIG. 1.

FIG. 5 is a top view of the coupling device of FIG. 1.

FIG. 6 is a perspective view of an example coupling assembly including two substantially identical coupling devices of FIG. 1.

FIG. 7 is a cross-sectional view of the coupling assembly of FIG. 6.

FIG. 8 is perspective view of another example coupling device.

FIG. 9 is a side view of the coupling device of FIG. 8.

FIG. 10 is a top view of the coupling device of FIG. 8.

FIG. 11 is a front view of the coupling device of FIG. 8.

FIG. 12 is a cross-sectional view of the coupling device of FIG. 8.

FIG. 13 is a perspective view of an example coupling assembly including two substantially identical coupling devices of FIG. 8.

FIG. 14 is a cross-sectional view of the coupling assembly of FIG. 13.

FIG. 15 is perspective view of another example coupling device.

FIG. 16 is a top view of the coupling device of FIG. 15.

FIG. 17 is a front view of the coupling device of FIG. 15.

FIG. 18 is a side view of the coupling device of FIG. 15.

FIG. 19 is a cross-sectional view of the coupling device of FIG. 15.

FIG. 20 is a perspective view of an example coupling assembly including two substantially identical coupling devices of FIG. 15.

FIG. 21 is a cross-sectional view of the coupling assembly of FIG. 20.

FIG. 22 is perspective view of another example coupling device.

FIG. 23 is a side view of the coupling device of FIG. 22.

FIG. 24 is a front view of the coupling device of FIG. 22.

FIG. 25 is a top view of the coupling device of FIG. 22.

FIG. 26 is a cross-sectional view of the coupling device of FIG. 22.

FIG. 27 is a perspective view of an example coupling assembly including two substantially identical coupling devices of FIG. 22.

FIG. 28 is a cross-sectional view of the coupling assembly of FIG. 27.

FIG. 29 is perspective view of another example coupling device.

FIG. 30 is a side view of the coupling device of FIG. 29.

FIG. 31 is a front view of the coupling device of FIG. 29.

FIG. 32 is a top view of the coupling device of FIG. 29.

FIG. 33 is a cross-sectional view of the coupling device of FIG. 29.

FIG. 34 is a perspective view of an example coupling assembly including two substantially identical coupling devices of FIG. 29.

FIG. 35 is a cross-sectional view of the coupling assembly of FIG. 34.

FIG. 36 is perspective view of another example coupling device.

FIG. 37 is a side view of the coupling device of FIG. 36.

FIG. 38 is a front view of the coupling device of FIG. 36.

FIG. 39 is a top view of the coupling device of FIG. 36.

FIG. 40 is a cross-sectional view of the coupling device of FIG. 36.

FIG. 41 is a perspective view of an example coupling assembly including two substantially identical coupling devices of FIG. 36.

FIG. 42 is a cross-sectional view of the coupling assembly of FIG. 41.

FIG. 43 is a perspective view of another example coupling device.

FIG. 44 is a front view of the coupling device of FIG. 43.

FIG. 45 is a top view of the coupling device of FIG. 43.

FIG. 46 is a side view of the coupling device of FIG. 43.

FIG. 47 is a cross-sectional view of the coupling device of FIG. 43.

FIG. 48 is a perspective view of another example coupling device.

FIG. 49 is a front view of the coupling device of FIG. 48.

FIG. 50 is a top view of the coupling device of FIG. 48.

FIG. 51 is a side view of the coupling device of FIG. 48.

FIG. 52 is a cross-sectional view of the coupling device of FIG. 48.

FIG. 53 is a perspective view of another example coupling device.

FIG. 54 is a front view of the coupling device of FIG. 43.

FIG. 55 is a top view of the coupling device of FIG. 43.

FIG. 56 is a side view of the coupling device of FIG. 43.

FIG. 57 is a cross-sectional view of the coupling device of FIG. 43.

FIG. 58 is a perspective view of another coupling device mated with the coupling device of FIG. 53.

FIG. 59 is a cross-sectional view of the coupling devices of FIG. 58.

FIG. 60 is a perspective view of another example coupling device.

FIG. 61 is a front view of the coupling device of FIG. 60.

FIG. 62 is a top view of the coupling device of FIG. 60.

FIG. 63 is a side view of the coupling device of FIG. 60.

FIG. 64 is a cross-sectional view of the coupling device of FIG. 60.

FIG. 65 is a perspective view of another coupling device mated with the coupling device of FIG. 60.

FIG. 66 is a cross-sectional view of the coupling devices of FIG. 65.

FIG. 67 is a perspective view of another example coupling device.

FIG. 68 is a front view of the coupling device of FIG. 67.

FIG. 69 is a top view of the coupling device of FIG. 67.

FIG. 70 is a side view of the coupling device of FIG. 67.

FIG. 71 is a cross-sectional view of the coupling device of FIG. 67.

FIG. 72 is a perspective view of another coupling device mated with the coupling device of FIG. 67.

FIG. 73 is a cross-sectional view of the coupling devices of FIG. 72.

### DETAILED DESCRIPTION

The present disclosure relates to a coupling assembly including two coupling devices. In the examples described, each of the coupling devices that form the coupling assembly is substantially identical. In such a configuration, the first coupling device is coupled to the second coupling device to form the coupling assembly. Additional details are provided below.

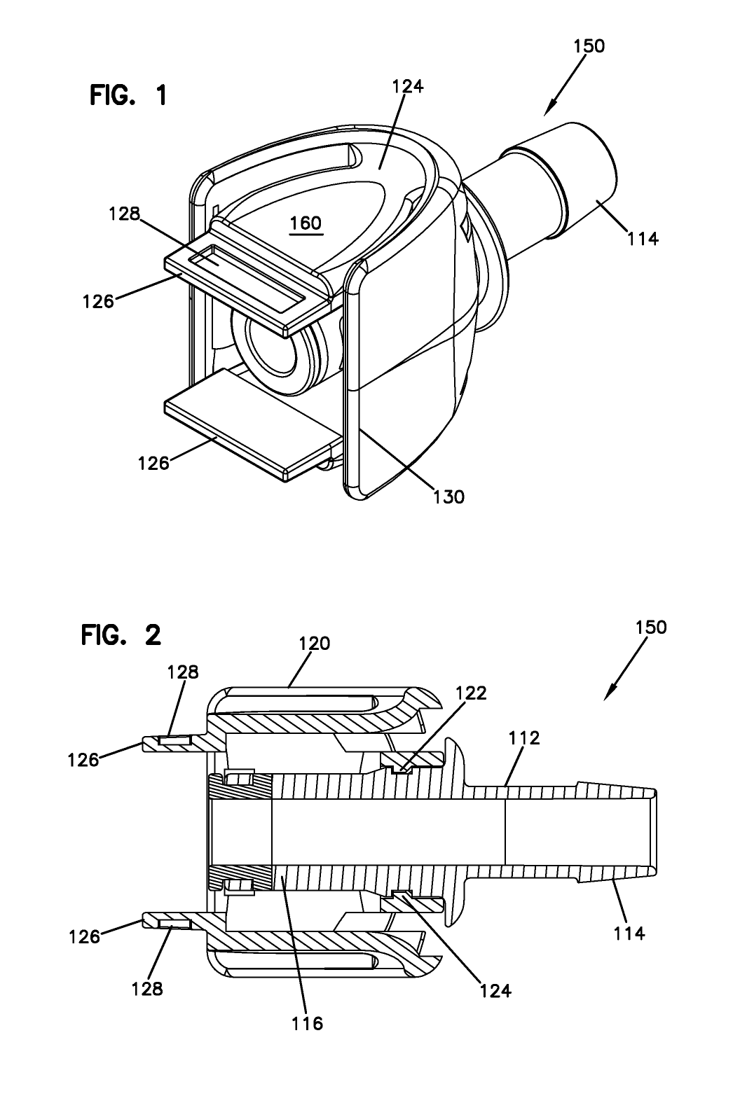

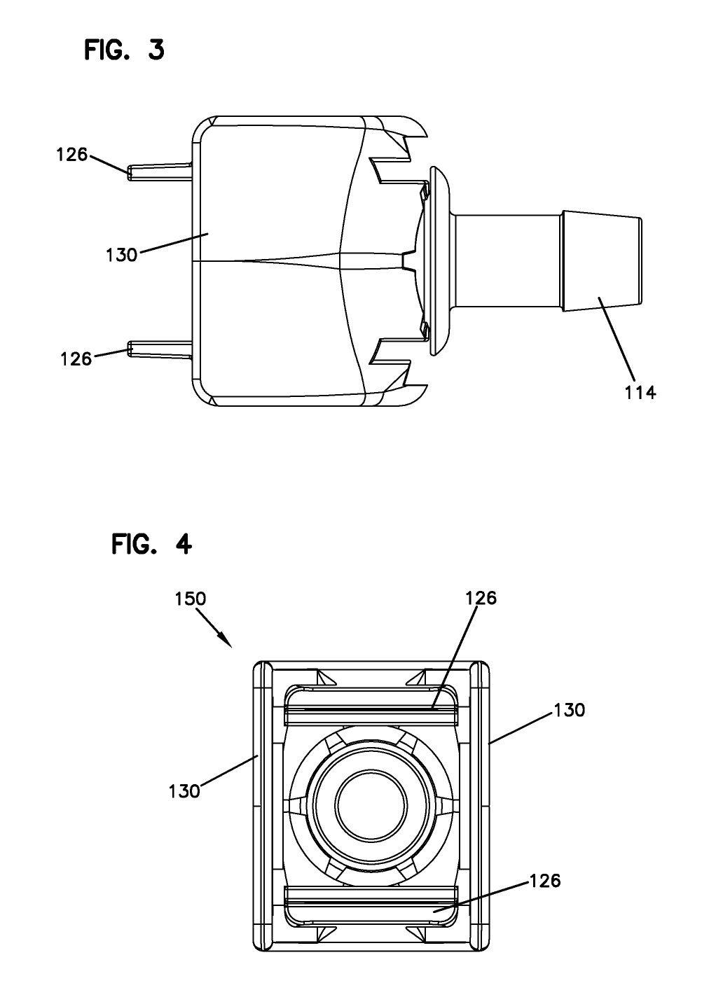

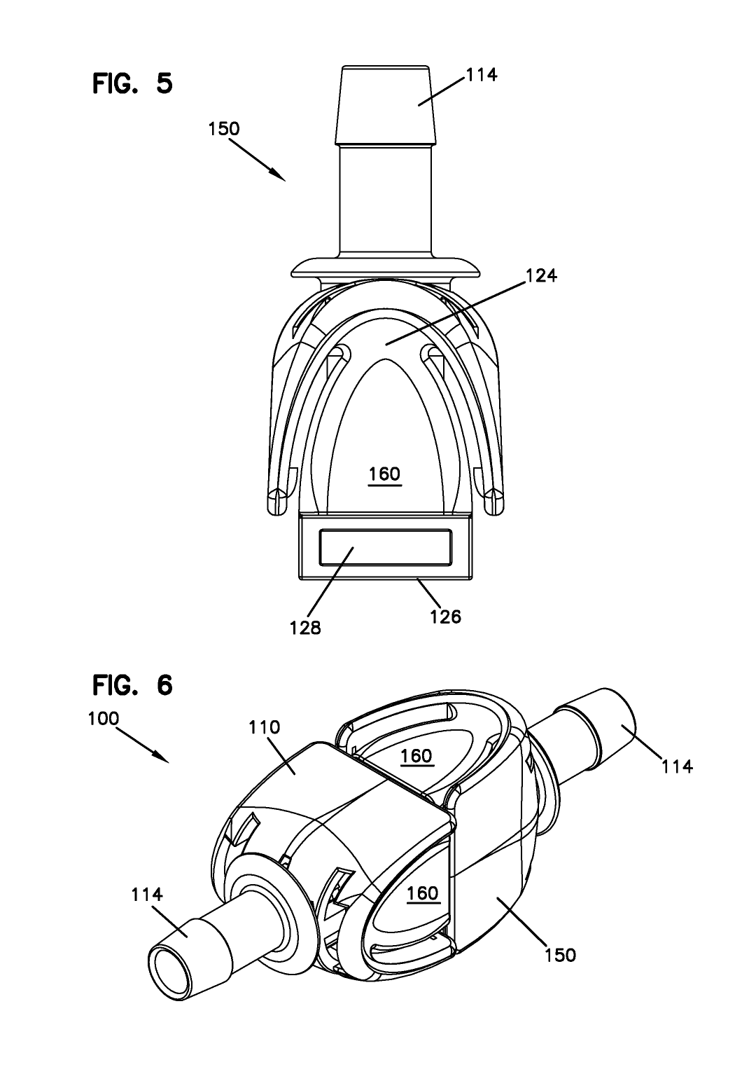

Referring now to FIGS. 1-7, an example coupling assembly 100 is shown. The coupling assembly 100 can be used to provide a passageway 102 for a fluid that is transferred between two points. The coupling assembly 100 includes a first coupling device 110 and a second coupling device 150.

In this example, the first and second coupling devices 110, 150 are substantially identical in configuration. Each of the first and second coupling devices 110, 150 includes a insert 112 including a termination 114 that is coupled to a fluid line, tubing or other similar structure. The insert 112 also includes a front portion 116 with an elastomer seal 118 coupled thereto. The elastomer seal 118 can be coupled to the front portion 116 using various techniques. For example, an adhesive or overmolding technique can be used. In other examples, a compression pocket or mechanical coupling like a protrusion is used. When connected, the elastomer seal 118 of the first coupling device 110 seals against the elastomer seal 118 of the second coupling device 150 to form the fluid passage.

In example embodiments, the seal 118 is formed in a general hourglass shape. This shape includes a mid-portion of the seal that is smaller in cross-section from the outer sides of the seal. This allows for a more uniform compression of the seal as the seal engages the seal of the mating coupling device.

A sleeve 120 is positioned about the front portion 116 of the insert 112. In some examples, the sleeve 120 is positioned on the insert 112 such that the sleeve 120 can rotate independently from the insert 112. In other configurations, the sleeve 120 is fixedly attached to the insert 112.

A main body 124 of the sleeve 120 includes a tab 122 that is captured in a groove formed by the insert 112 to connect the sleeve 120 to the insert 112. Flange portions 126 extend from the main body 124 and form opposing grooves 128. In addition, portions 130 extend from the main body 124 and form tabs 132.

To connect the first and second coupling devices 110, 150, the first coupling device 110 is rotated ninety degrees relative to the second coupling device 150 so that the flange portions 126 of the first coupling device 110 engage the portions 130 of the second coupling device 150.

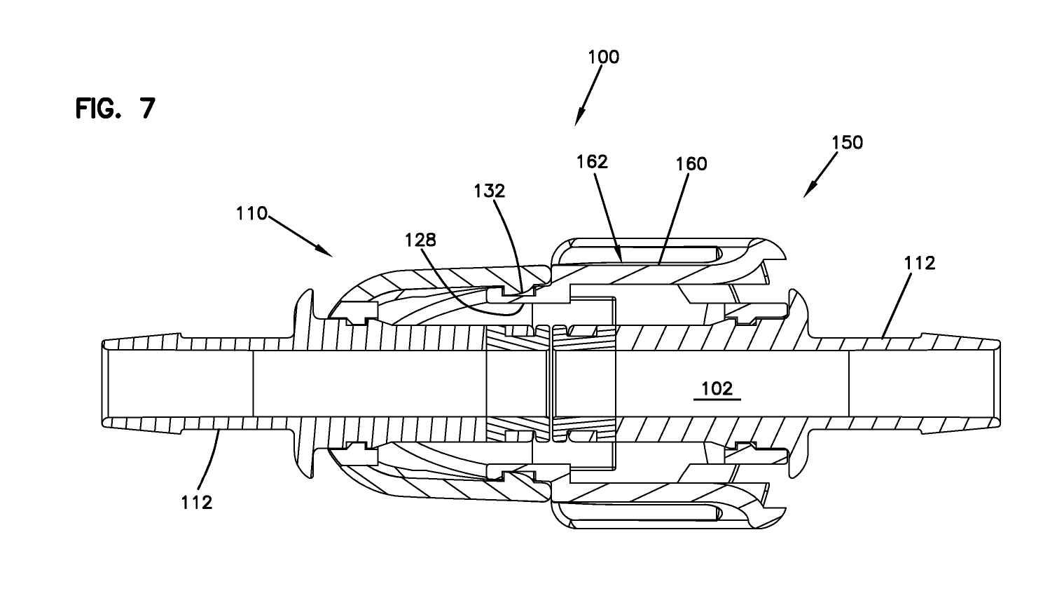

As shown in FIG. 7, as the first coupling device 110 is moved towards the second coupling device 150, the elastomer seal 118 of the first coupling device 110 engages the elastomer seal 118 of the second coupling device 150 to form an axial (or face) seal therebetween. In addition, in this position, tabs 132 of the portions 130 are positioned in the opposing grooves 128 of the flange portions 126 so that the first coupling device 110 is connected to the second coupling device 150. This creates a substantially leak-free passageway 102 between the first and second coupling devices 110, 150.

To disconnect the first coupling device 110 from the second coupling device 150, a force 162 is applied to each opposing surface 160 of the main body 124 of each of the first and second coupling devices 110, 150. This causes the flange portions 126 to bow slightly towards one another and to allow the tabs 132 of the portions 130 to clear the grooves 128 of the flange portions 126. In this configuration, the first coupling device 110 can be moved away from the second coupling device 150 to accomplish disconnection. Reconnection and disconnection can be done multiple times as noted above.

Because the first and second coupling devices 110, 150 are substantially similar, the two sides are genderless in that there are no separate male and female coupling devices. In other words, any first coupling device 110 can be coupled to any second coupling device 150 by simply orienting the two devices in the proper manner. Such a configuration can be advantageous in that the connections are flexible and can be made efficiently.

The first and second coupling devices 110, 150 can be made of a variety of materials. Example materials include polycarbonate, polysulfone, polypropylene, PVDF, Nylon, ABS, and Acetal. In other examples, two or more materials can be combined to form the devices.

The elastomer seals 118 can also be made of a variety of materials, such as a thermoset rubber. Examples of such materials include silicone, EPDM, FKM, BUNA, and/or a perfluoroelastromer. Thermoplastic elastomers (TPEs) could also be used.

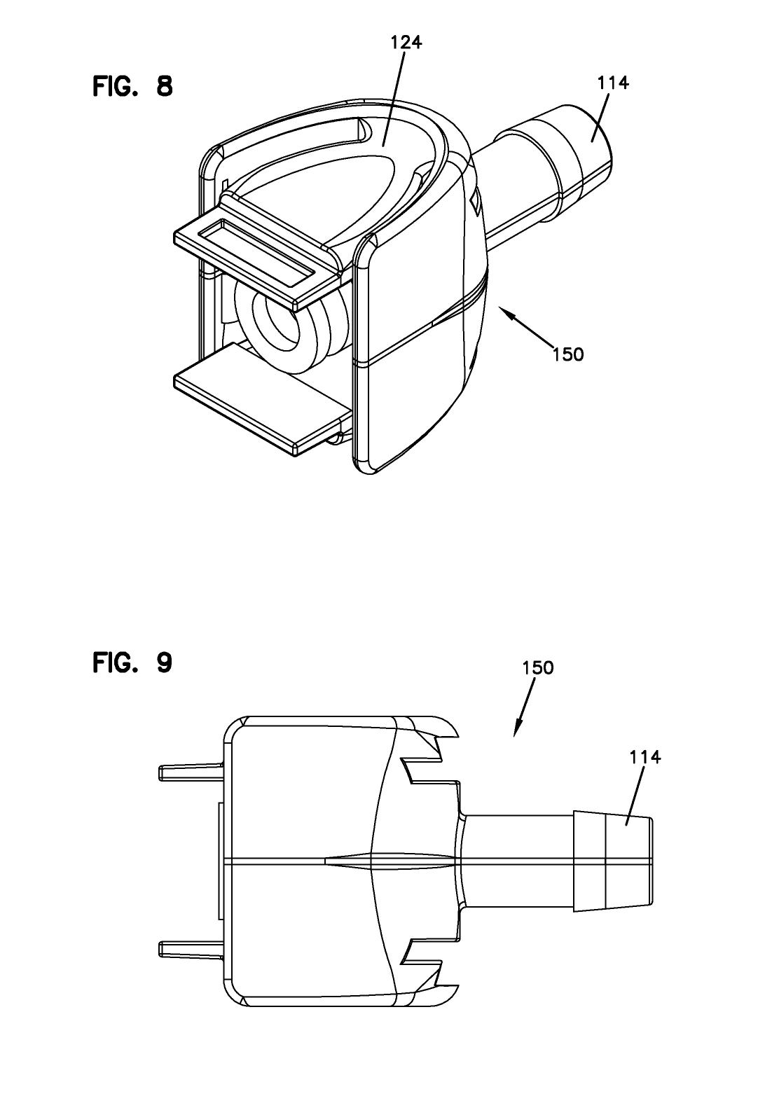

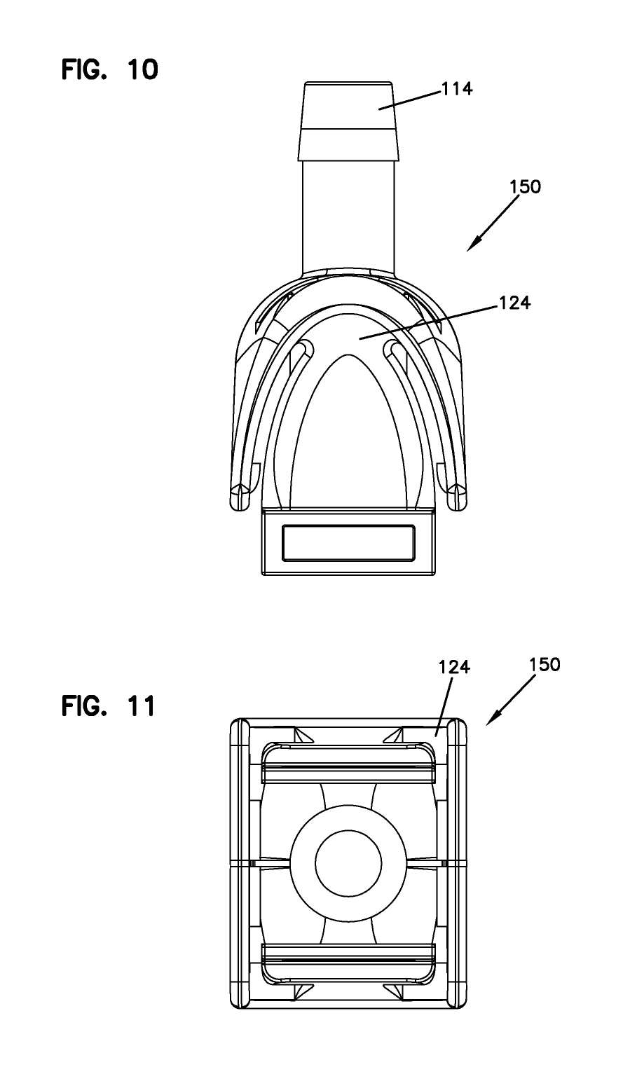

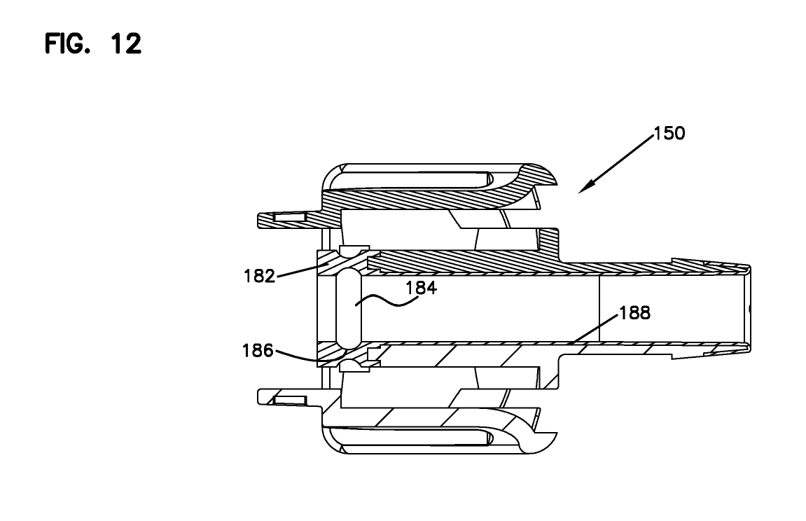

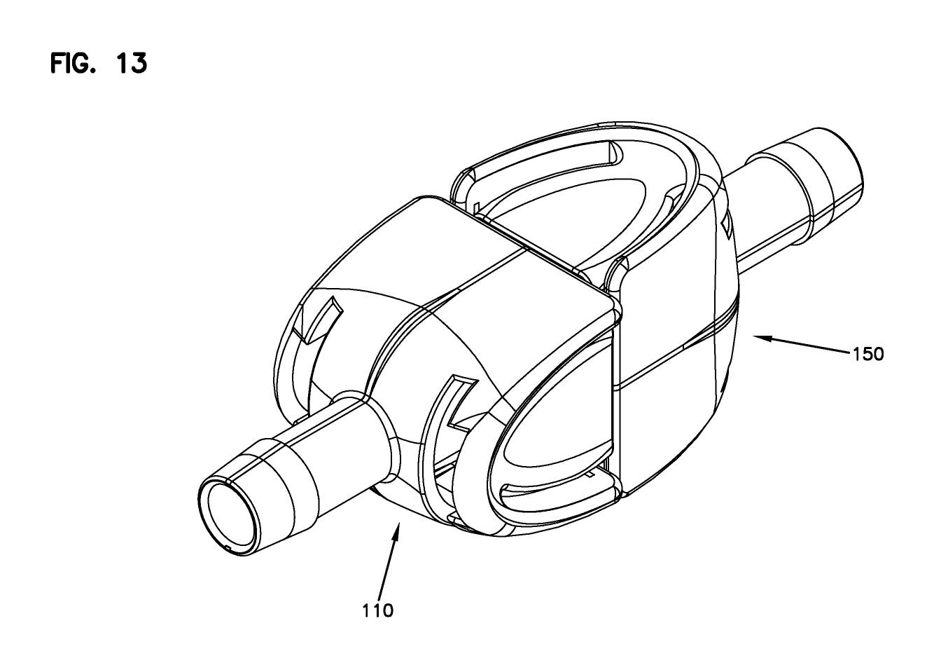

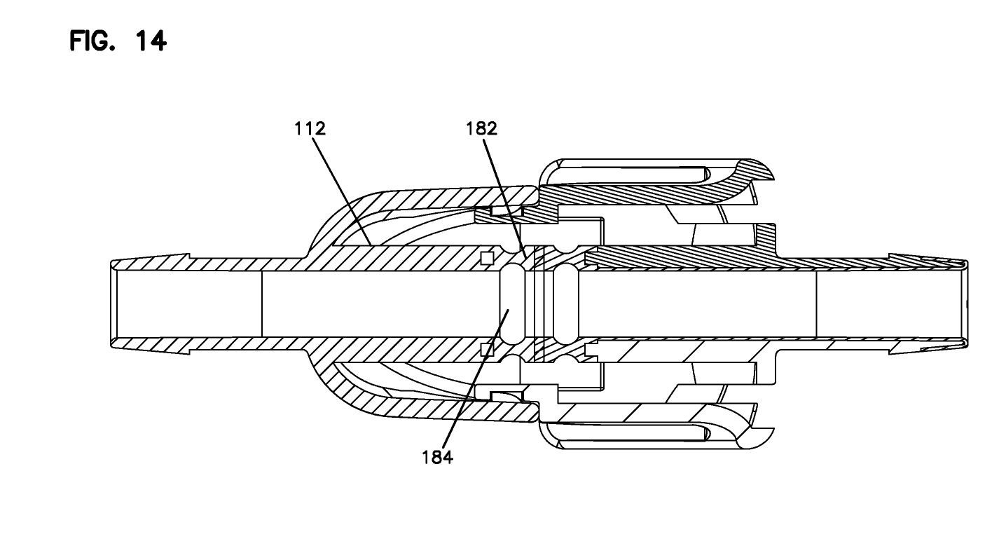

Referring now to FIGS. 8-14, another example coupling assembly 180 is shown. The coupling assembly 180 is substantially the same as the coupling assembly 100 described above. However, the insert 112 includes an overmolded elastomer seal 182 that is formed on the insert 112 using, for example, a two-shot molding process. A detent 186 formed on the interior surface 188 of the insert 112 captures the overmolded elastomer seal 182. The seals 182 of each of the coupling devices 110, 150 form an axial or face seal as described above when coupled.

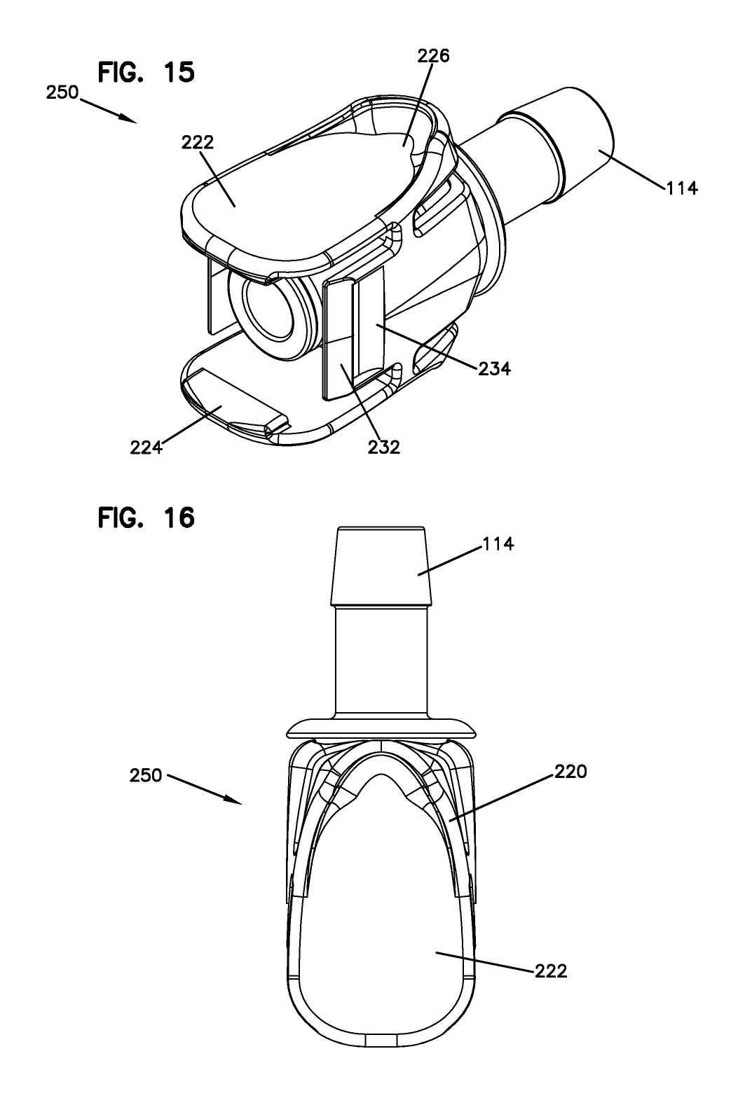

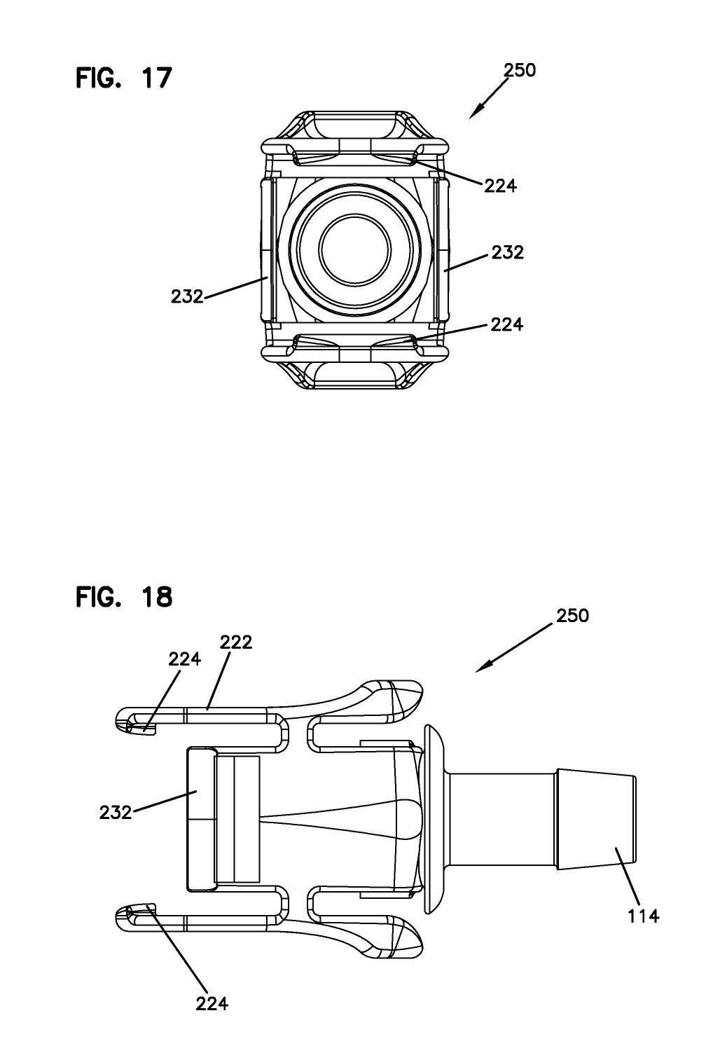

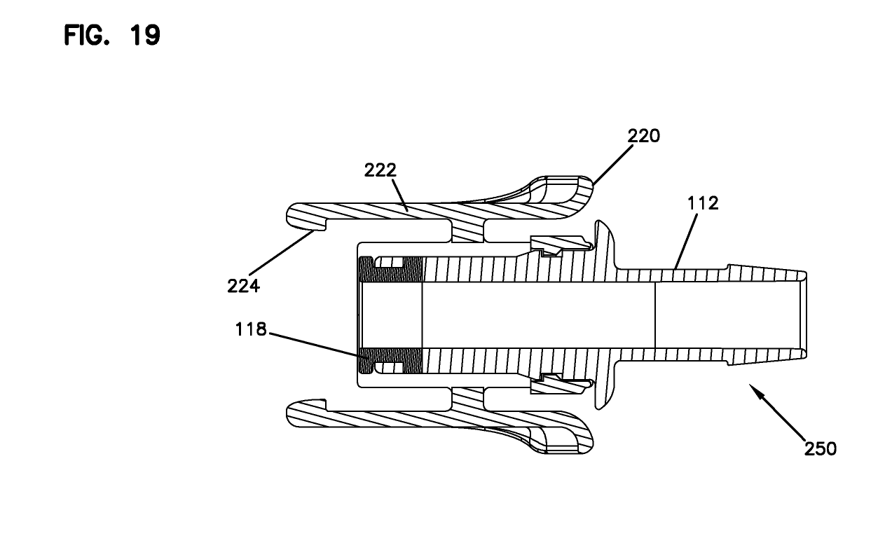

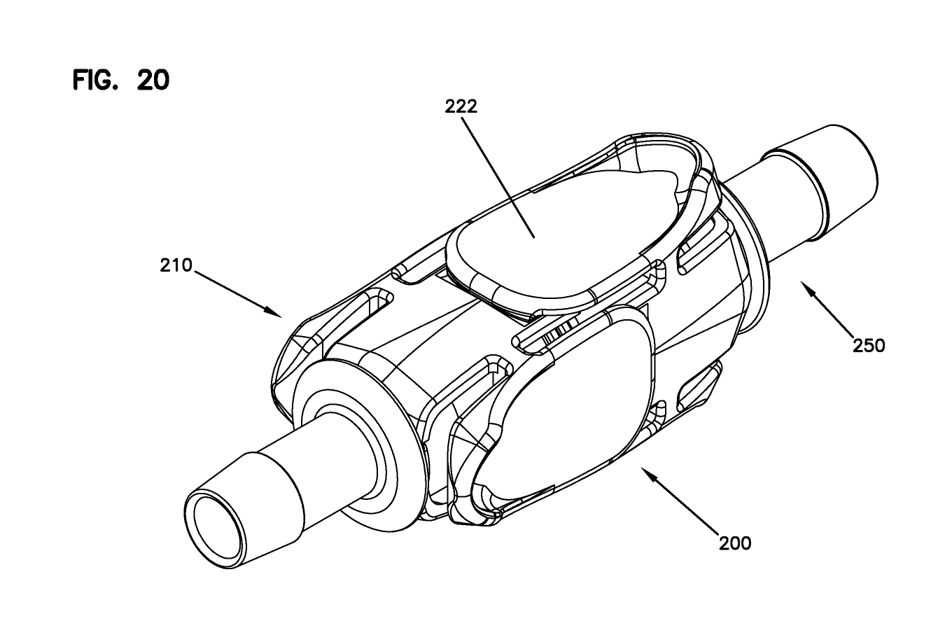

Referring now to FIGS. 15-21, another example coupling assembly 200 is shown. The coupling assembly 200 is similar to the coupling assembly 100 described above.

However, the coupling assembly 200 includes first and second coupling devices 210, 250 with opposing members 222 having tabs 224. In addition, the devices 210, 250 include flange portions 232 with grooves 234 formed thereon.

To couple the first coupling device 210 to the second coupling device 250 to form the axial seal between the elastomer seals 118, the first coupling device 210 is rotated ninety degrees relative to the second coupling device 250 so that the flange portions 232 of the first coupling device 210 engage the opposing members 222 of the second coupling device 250.

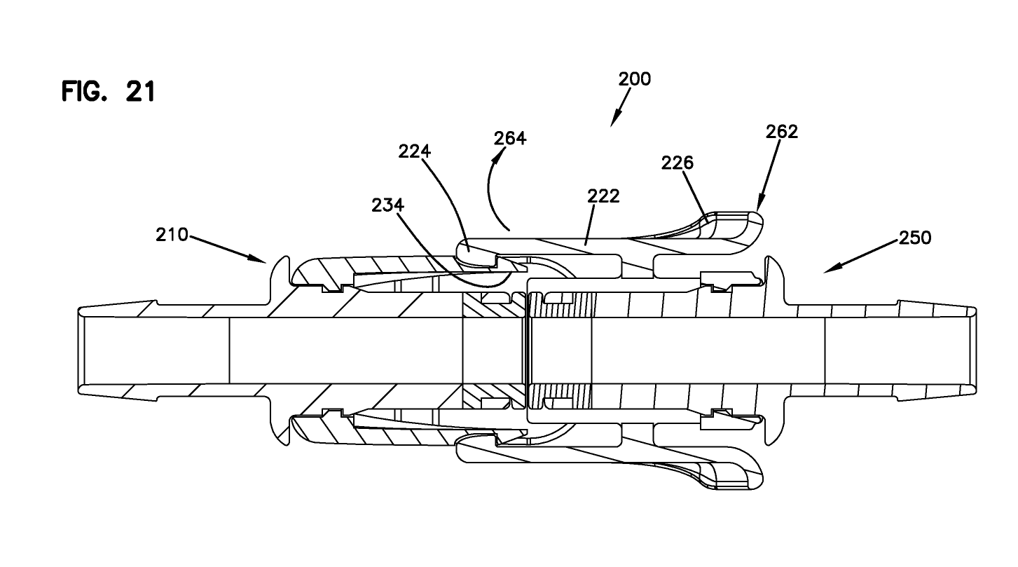

As shown in FIG. 21, as the first coupling device 210 is moved towards the second coupling device 250, the elastomer seal 118 of the first coupling device 210 engages the elastomer seal 118 of the second coupling device 250 to form an axial seal therebetween. In addition, in this position, tabs 224 of the opposing members 222 are positioned in the opposing grooves 234 of the flange portions 232 so that the first coupling device 210 is connected to the second coupling device 250.

To disconnect the first coupling device 210 from the second coupling device 150, a force 262 is applied to an end 226 of each opposing member 222 of the first and second coupling devices 210, 250. This causes the opposing members 222 to move in a direction 264 and allows the tabs 224 of the opposing members 222 to clear the grooves 234 of the flange portions 232. In this configuration, the first coupling device 210 can be moved away from the second coupling device 250 to accomplish disconnection. Reconnection and disconnection can be done multiple times as noted above.

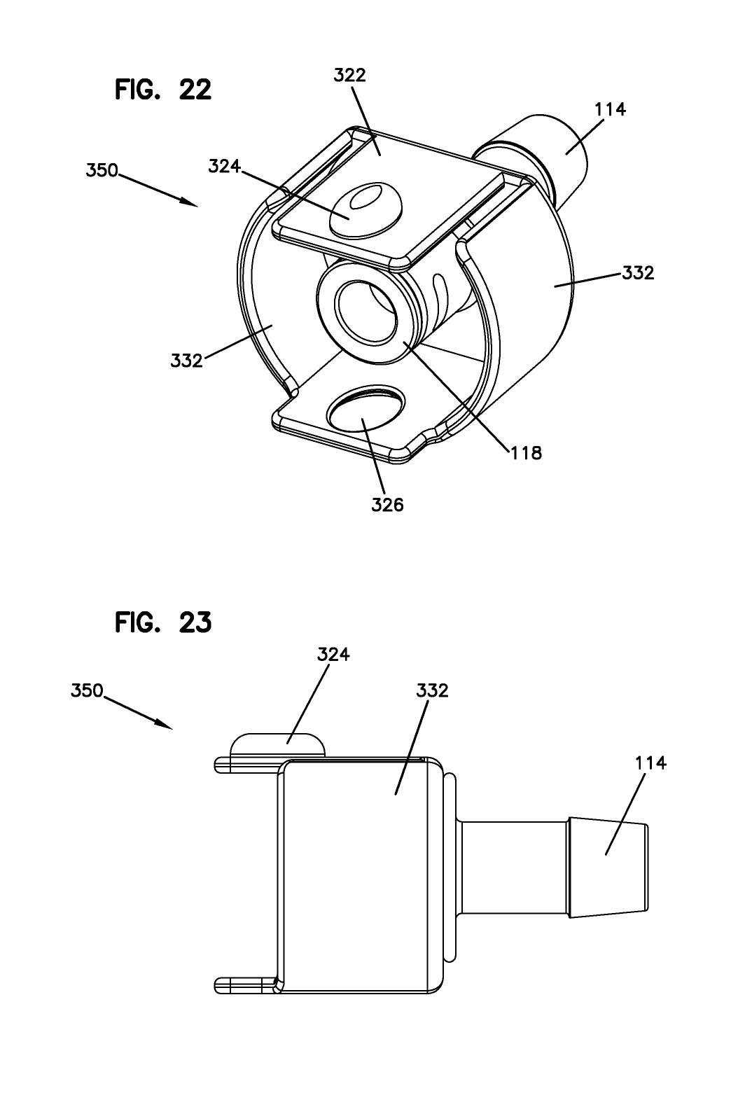

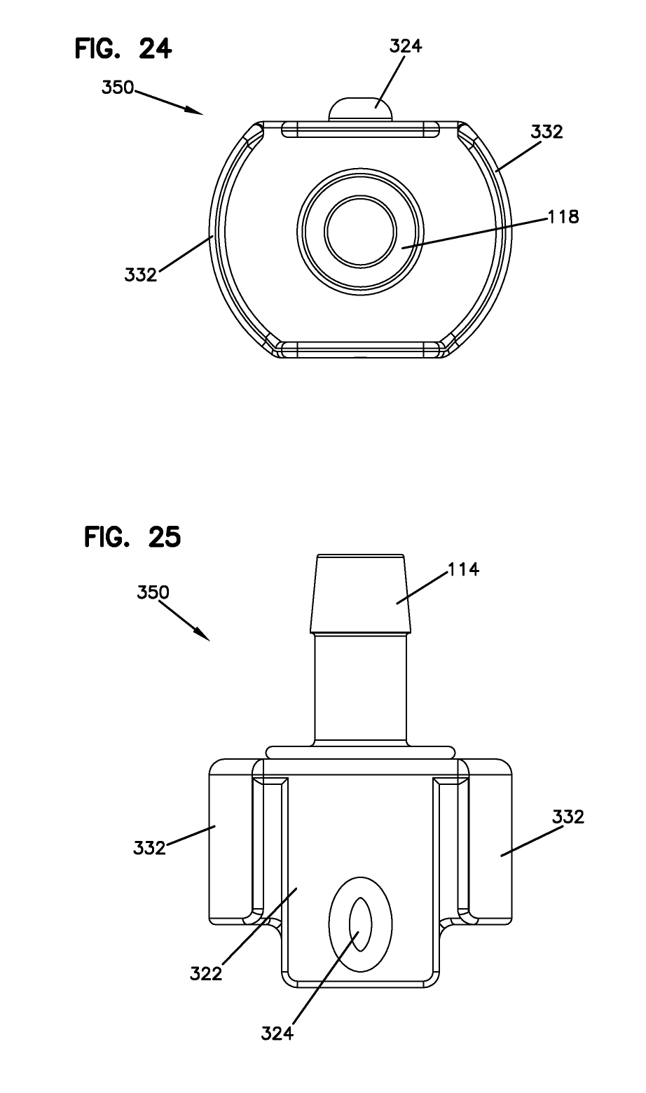

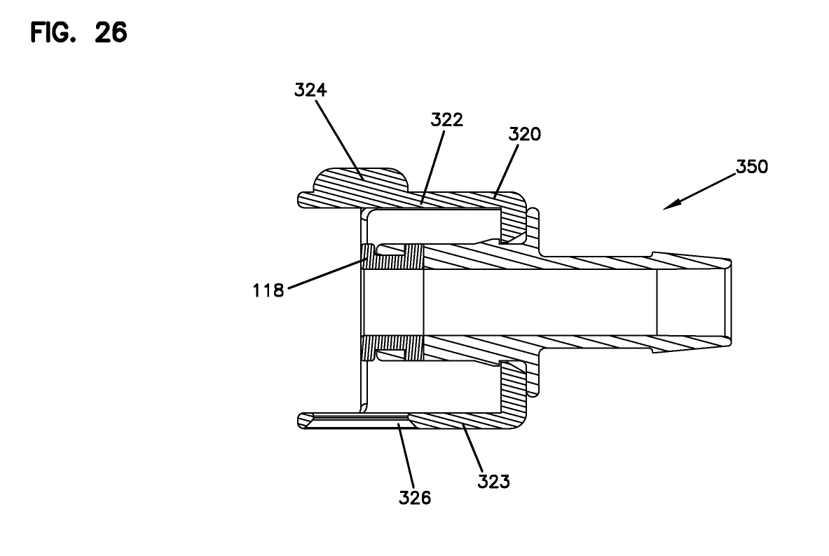

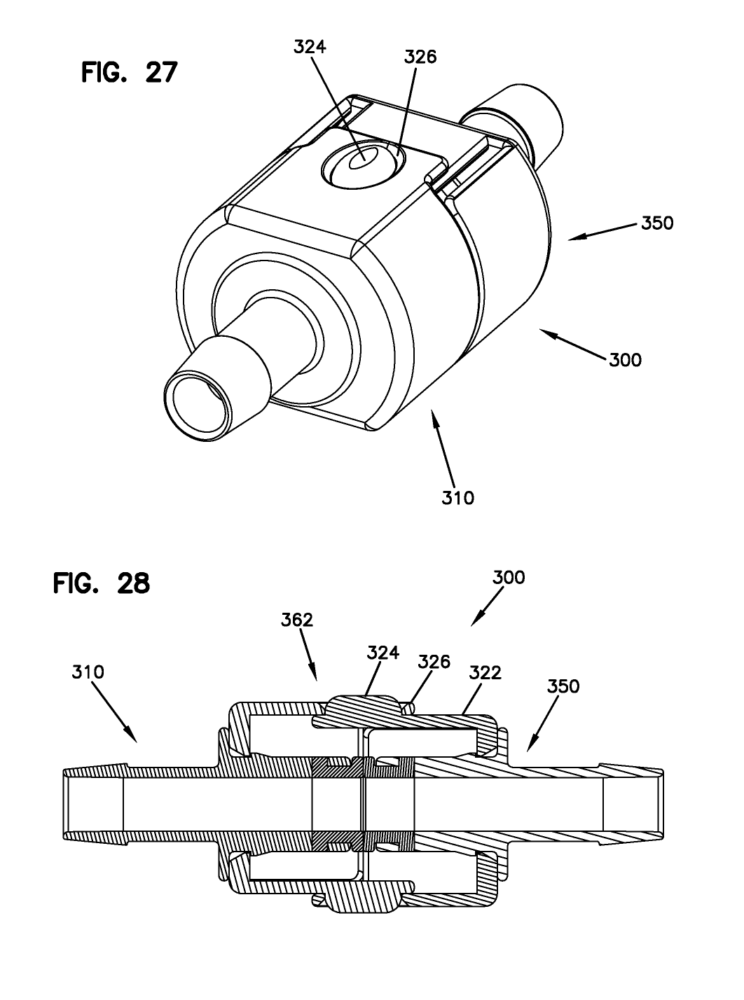

Referring now to FIGS. 22-28, another example coupling assembly 300 is shown. The coupling assembly 300 is similar to the coupling assemblies 100, 200 described above.

However, the coupling assembly 300 includes first and second coupling devices 310, 350 with members 322, 323. The member 322 includes a tab 324, and the member 232 includes an opening 326. In addition, the devices 310, 350 include flange portions 332.

To couple the first coupling device 310 to the second coupling device 350 to form the axial seal between the elastomer seals 118, the first coupling device 310 is rotated 180 degrees relative to the second coupling device 350 so that tab 324 of the member 322 is positioned to engage the opening 326 of the member 323.

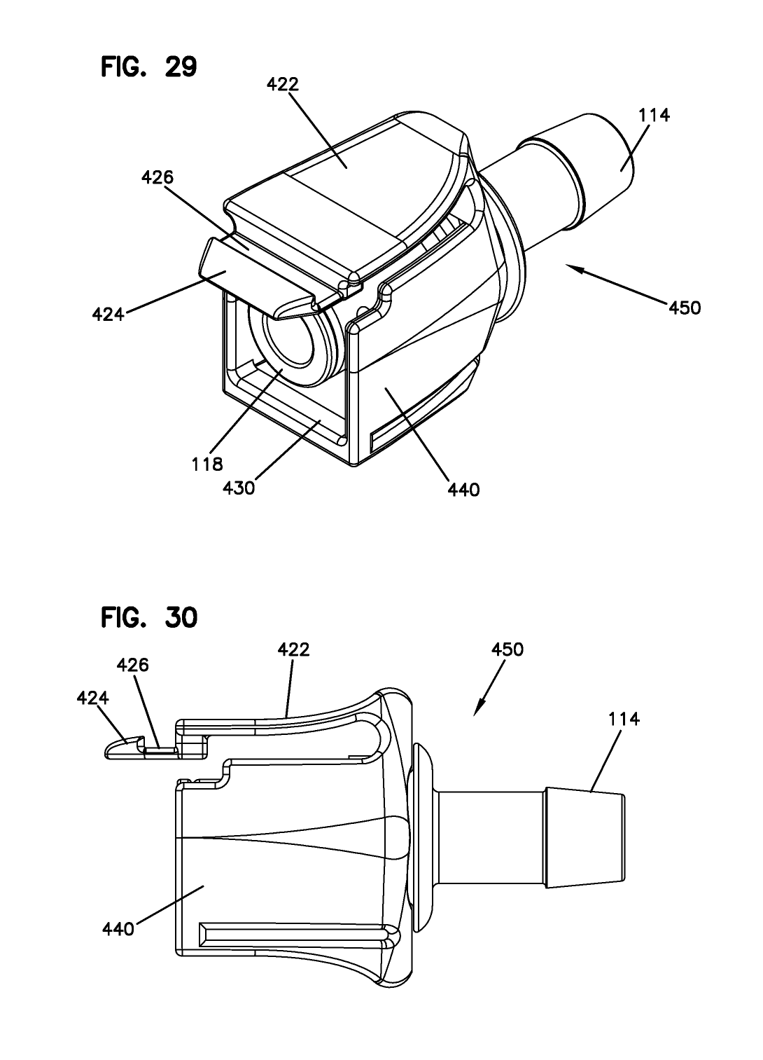

As shown in FIG. 28, as the first coupling device 310 is moved towards the second coupling device 350, the elastomer seal 118 of the first coupling device 310 engages the elastomer seal 118 of the second coupling device 350 to form an axial seal therebetween. In addition, in this position, the tab 324 is positioned in the opening 326 so that the first coupling device 310 is connected to the second coupling device 350.

To disconnect the first coupling device 310 from the second coupling device 350, a force 362 is applied to the tab 324. This causes the member 322 to move towards the member 323 and allows the tab 324 to clear the opening 326. In this configuration, the first coupling device 310 can be moved away from the second coupling device 350 to accomplish disconnection. Reconnection and disconnection can be done multiple times as noted above.

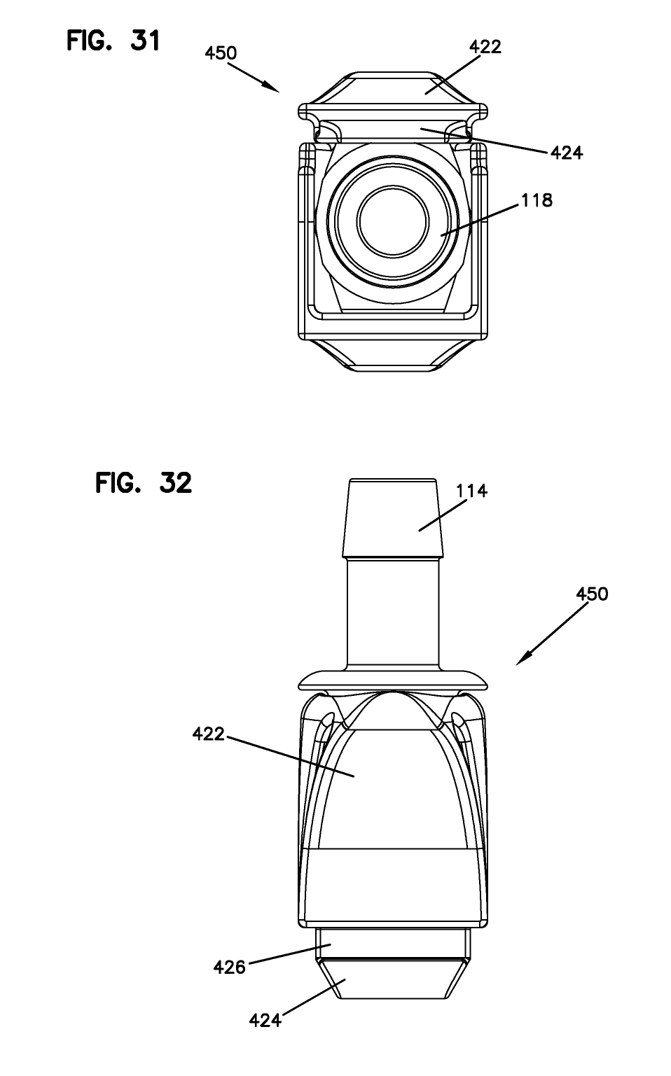

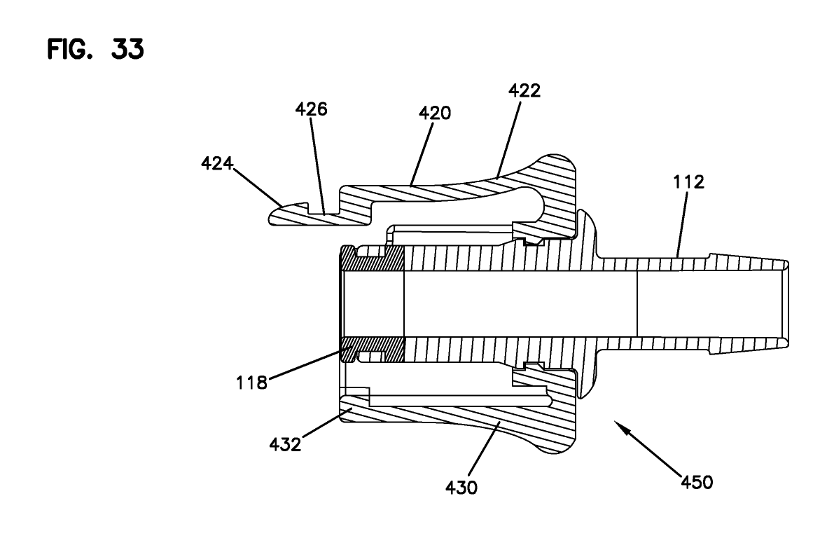

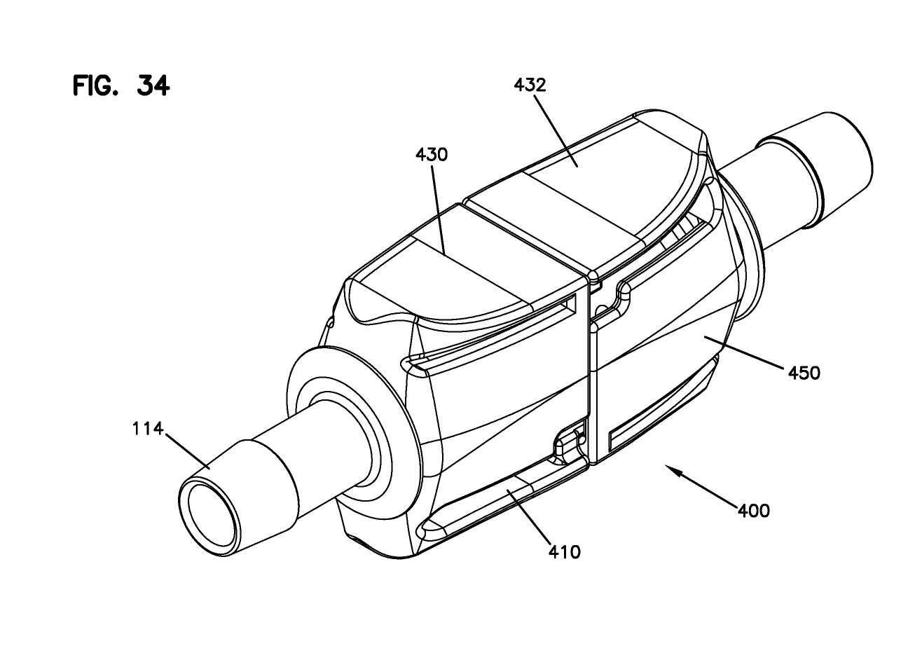

Referring now to FIGS. 28-35, another example coupling assembly 400 is shown. The coupling assembly 400 is similar to the coupling assemblies 100, 200, 300 described above.

However, the coupling assembly 400 includes first and second coupling devices 410, 450 with members 422,430. The member 422 includes a tab 424 and a groove 426, and the member 430 includes a tab 432. In addition, the devices 410, 450 include flange portions 440.

To couple the first coupling device 410 to the second coupling device 450 to form the axial seal between the elastomer seals 118, the first coupling device 410 is rotated 180 degrees relative to the second coupling device 450 so that tab 424 of the member 422 is positioned to engage the tab 432 of the member 430, and the tab 432 is positioned to be received into the groove 426 of the member 422.

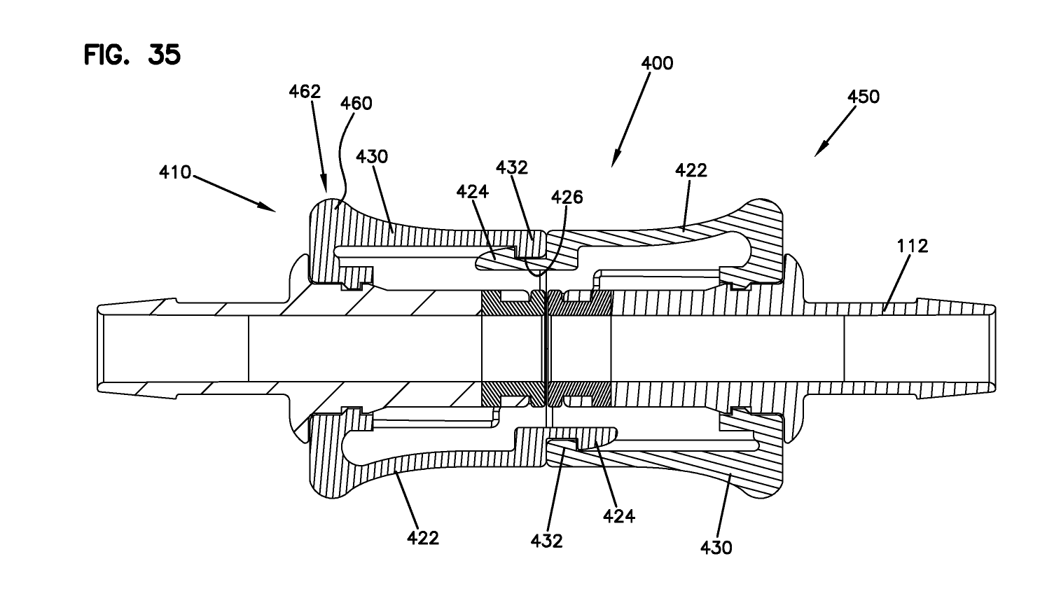

As shown in FIG. 35, as the first coupling device 410 is moved towards the second coupling device 450, the elastomer seal 118 of the first coupling device 410 engages the elastomer seal 118 of the second coupling device 450 to form an axial seal therebetween. In addition, in this position, the tab 432 is positioned in the groove 426 so that the first coupling device 410 is connected to the second coupling device 450.

To disconnect the first coupling device 410 from the second coupling device 450, a force 462 is applied to a portion 460 of each of the members 430. This causes the members 430 to move away from the members 422 and allows the tab 432 to clear the groove 426. In this configuration, the first coupling device 410 can be moved away from the second coupling device 450 to accomplish disconnection. Reconnection and disconnection can be done multiple times as noted above.

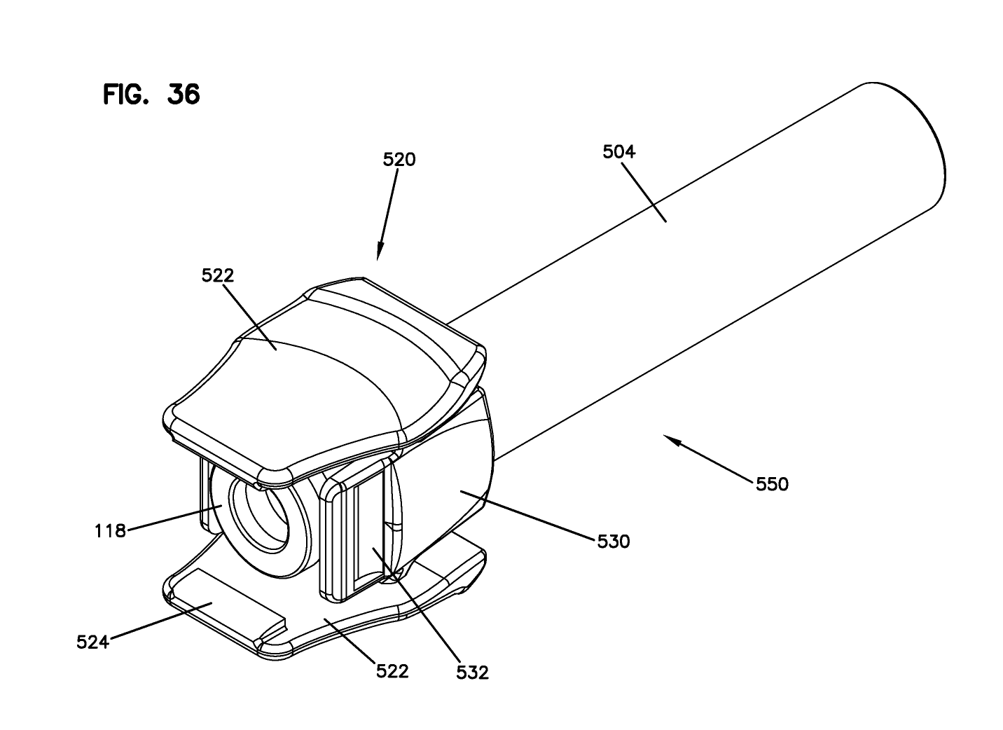

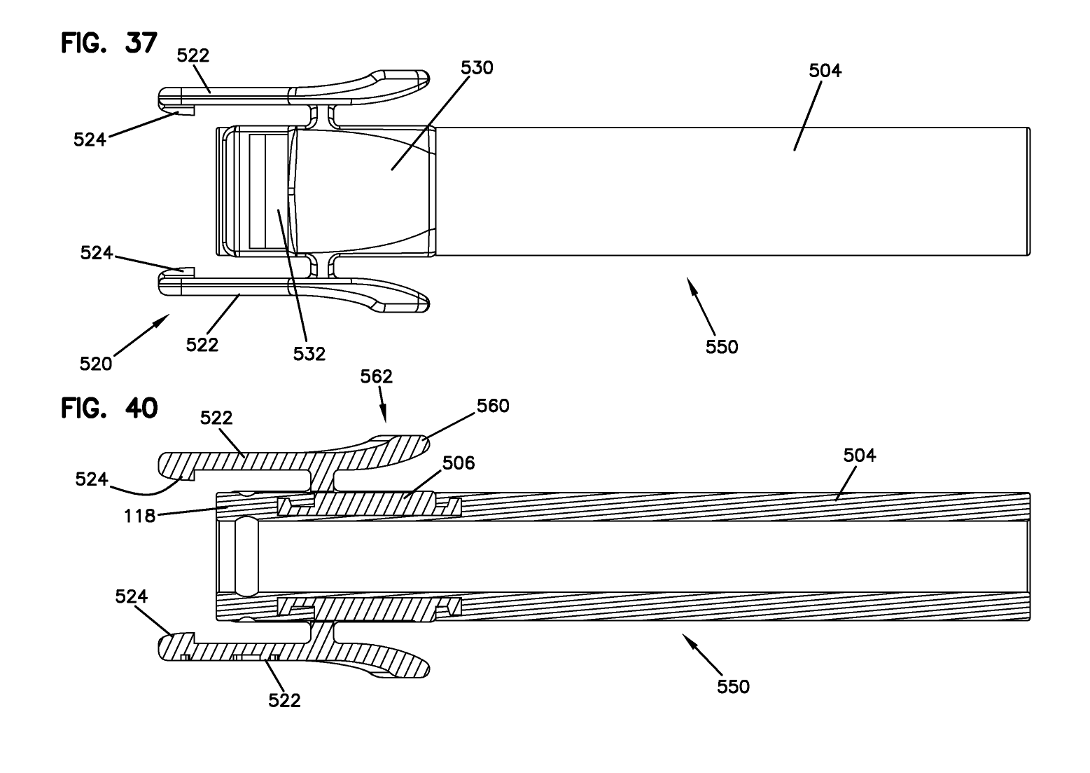

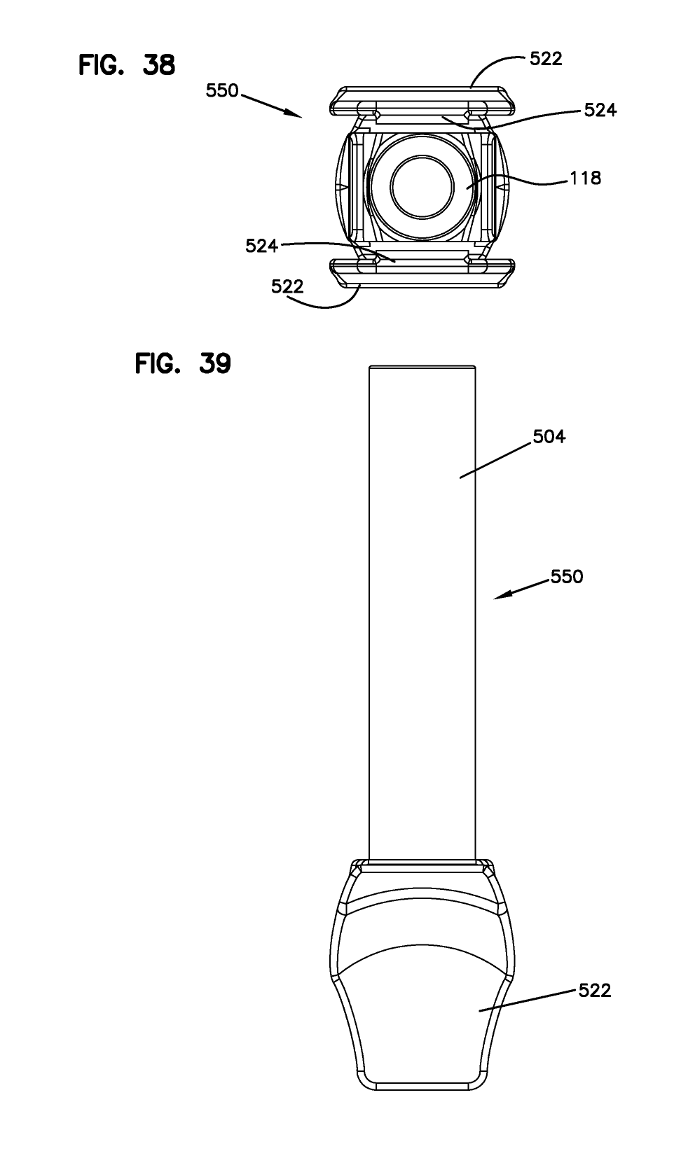

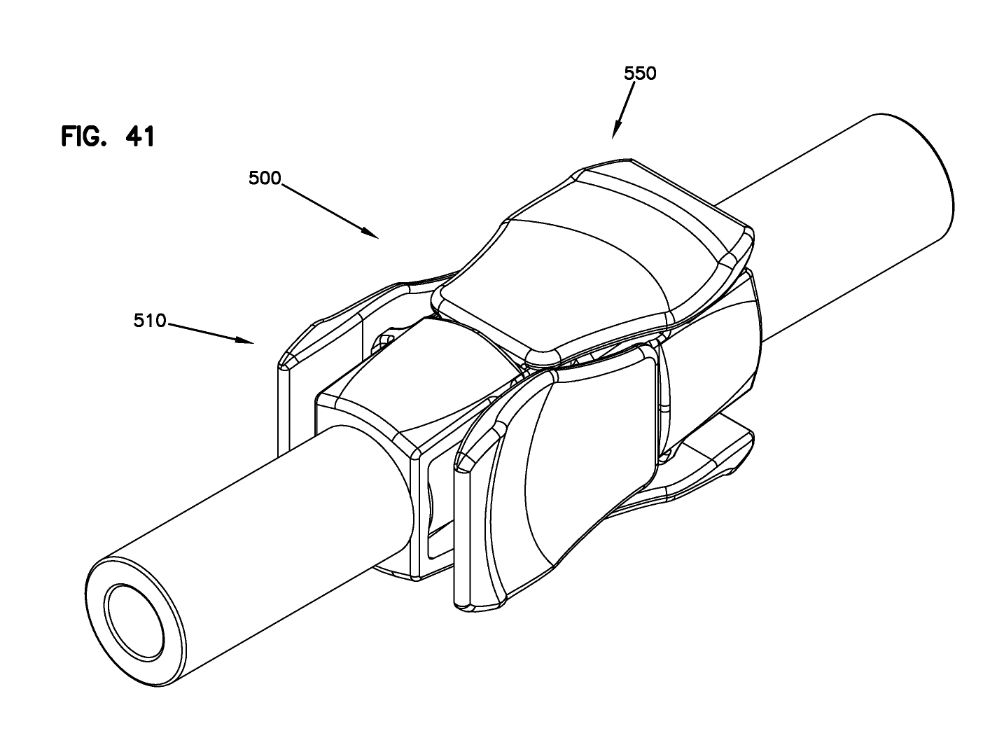

Referring now to FIGS. 36-42, another example coupling assembly 500 is shown. The coupling assembly 500 is similar to the coupling assemblies 100, 200, 300, 400 described above.

However, the coupling assembly 500 includes first and second coupling devices 510, 550 each with an insert 506 that is formed integrally with tubing 504 that extends from the source and/or destination of a fluid. In this example, the insert 506 is affixed to the tubing 504 using a process such as overmolding, welding, staking, or the like. The elastomer seal 118 is affixed to an opposite end of the sleeve 506 using an overmolding process.

Each of the coupling devices 510, 500 also includes a sleeve 520 rotatably coupled to the insert 506 and having members 522, 430. The member 522 includes a tab 524, and the member 530 includes a groove 532.

To couple the first coupling device 510 to the second coupling device 550 to form the axial seal between the elastomer seals 118, the first coupling device 510 is rotated ninety degrees relative to the second coupling device 550 so that the tab 524 of the member 522 is positioned to engage the groove 532 of the member 530.

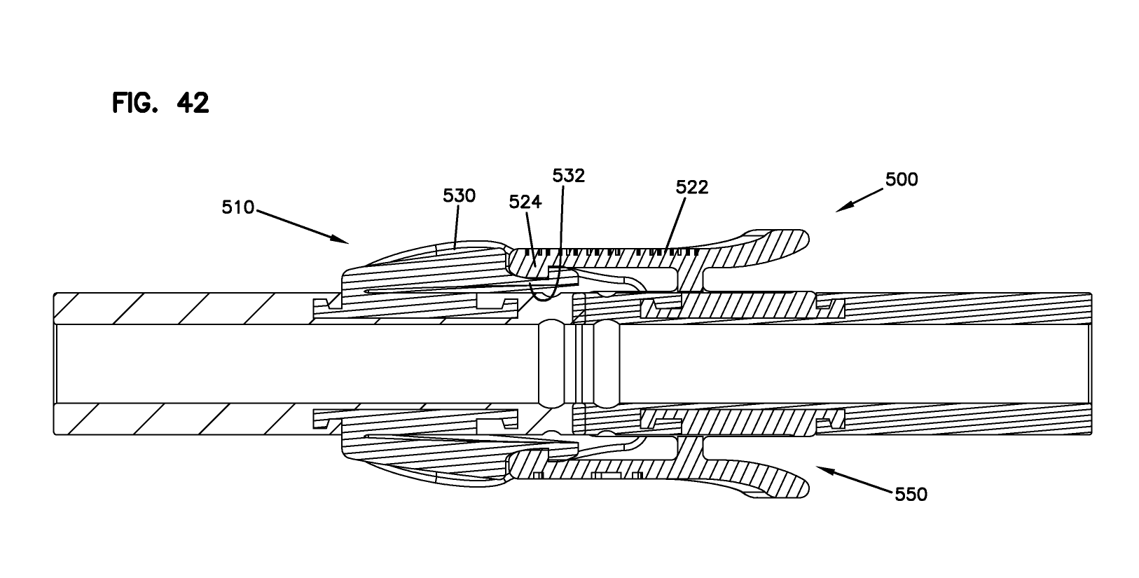

As shown in FIG. 42, as the first coupling device 510 is moved towards the second coupling device 550, the elastomer seal 118 of the first coupling device 510 engages the elastomer seal 118 of the second coupling device 550 to form an axial seal therebetween. In addition, in this position, the tab 524 is positioned in the groove 532 so that the first coupling device 510 is connected to the second coupling device 550.

To disconnect the first coupling device 510 from the second coupling device 550, a force 562 is applied to a portion 560 of each of the members 530. This causes the members 522 to move away from one another and allows the tab 524 to clear the groove 532. In this configuration, the first coupling device 510 can be moved away from the second coupling device 550 to accomplish disconnection. Reconnection and disconnection can be done multiple times as noted above.

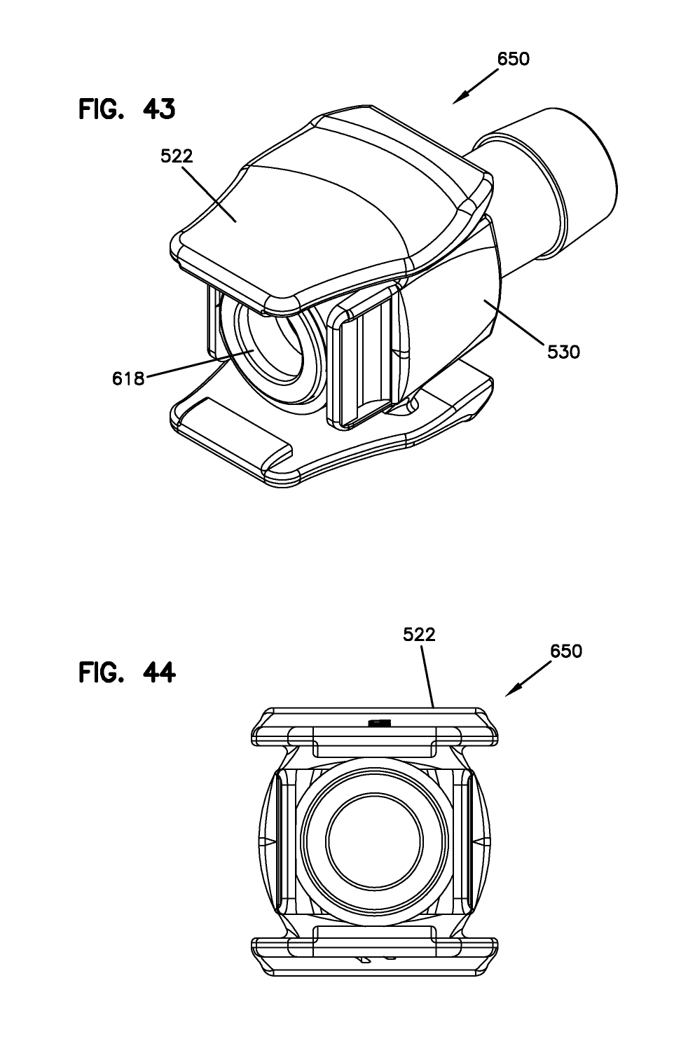

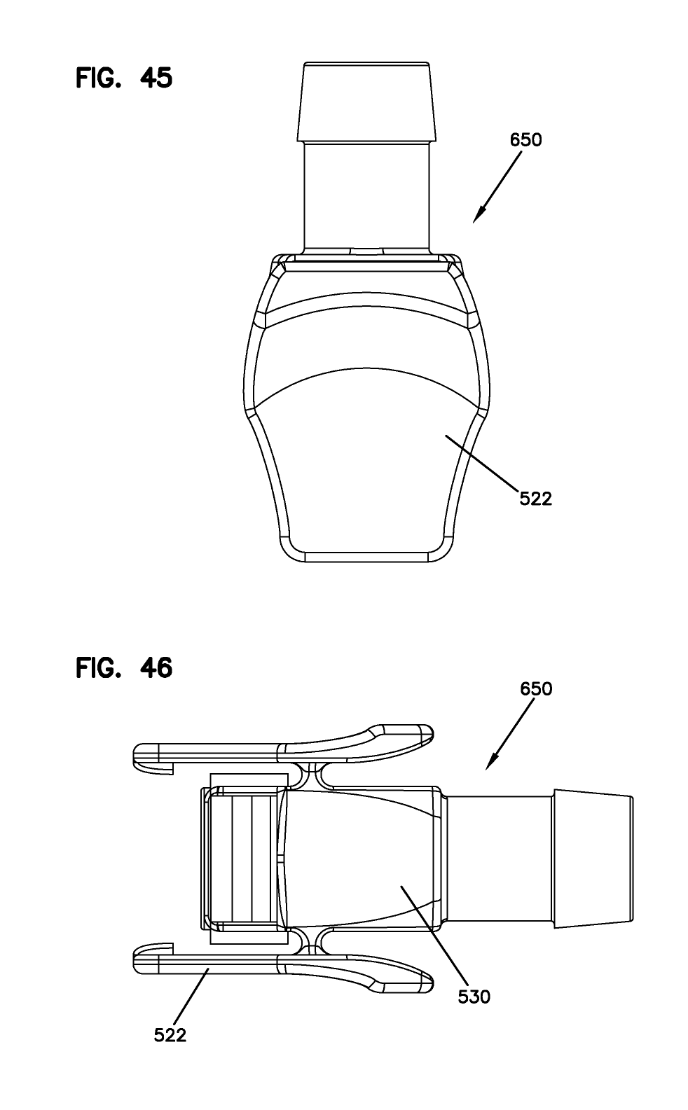

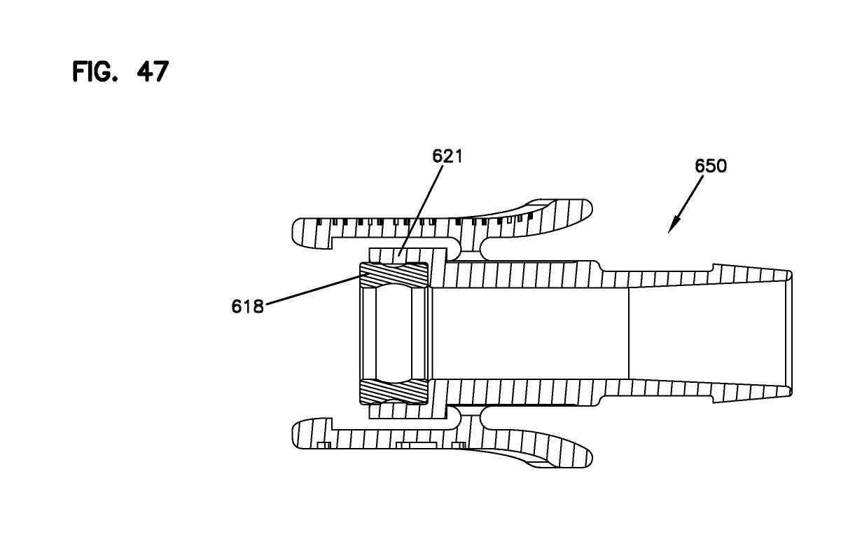

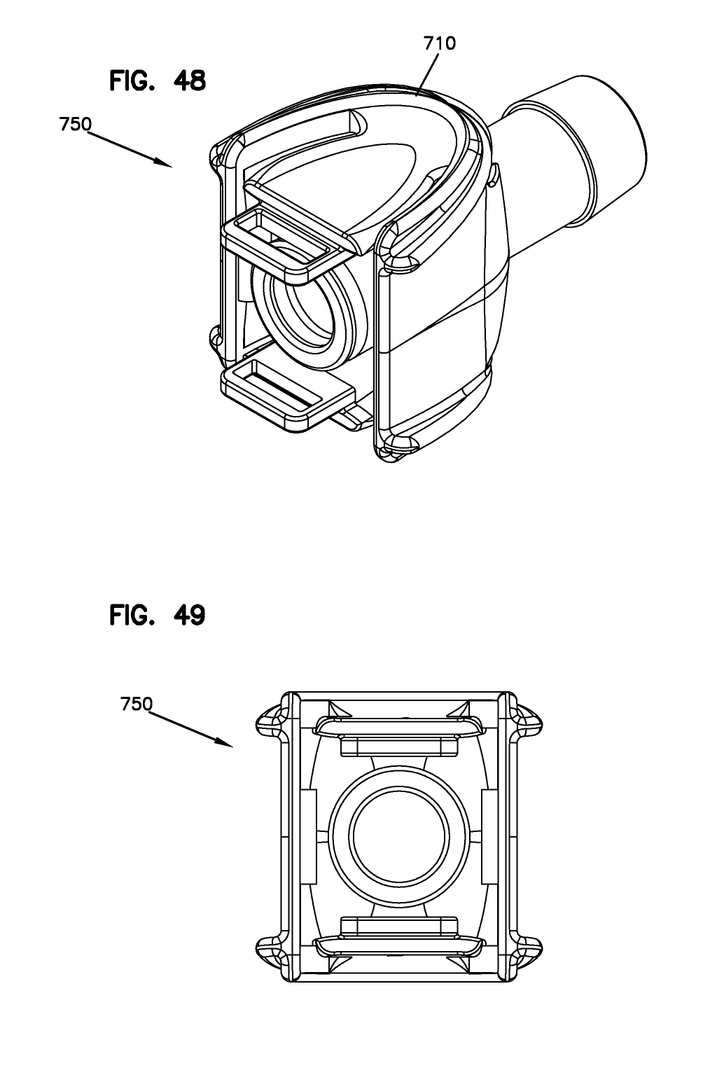

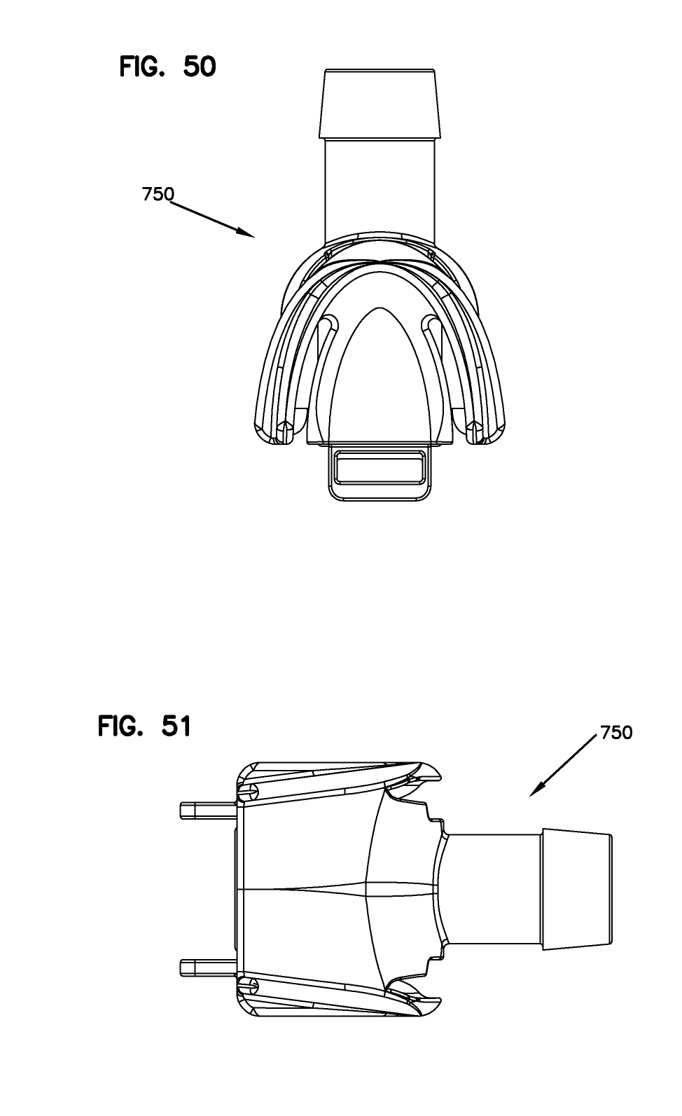

Referring now to FIGS. 43-47, another example coupling device 650 is shown. The coupling device 650 is similar to that of coupling devices 510, 550. However, the coupling device 650 includes a pocket 621. The pocket 621 is sized to receive and hold an elastomeric seal 618. In one example, the seal 618 is held in the pocket 621 using friction. In other examples, an adhesive or other structural elements can be used to retain the seal 618. One example of such a seal is described in U.S. patent application Ser. No. 13/693,720 filed on Dec. 4, 2012, the entirety of which is hereby incorporated by reference.

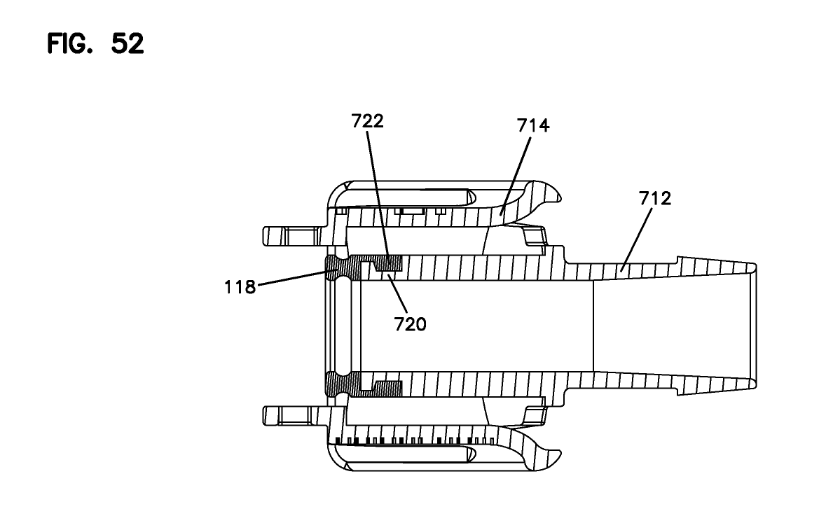

Referring now to FIG. 48-52, another example coupling device 750 is shown. The coupling device 750 is similar to that of coupling devices 110, 150. However, the coupling device 750 includes an insert 712 and sleeve 714 that are formed as an integral member 710. In such a configuration, the member 710 is used to terminate a fluid line, and it is not necessary for the insert 712 and sleeve 714 to be assembled separately.

Also, the insert 712 of the coupling device 750 includes a groove 720 formed therein. The groove 720 is sized to receive a portion 722 of the elastomer seal 118 to retain the elastomer seal 118 attached to the insert 712.

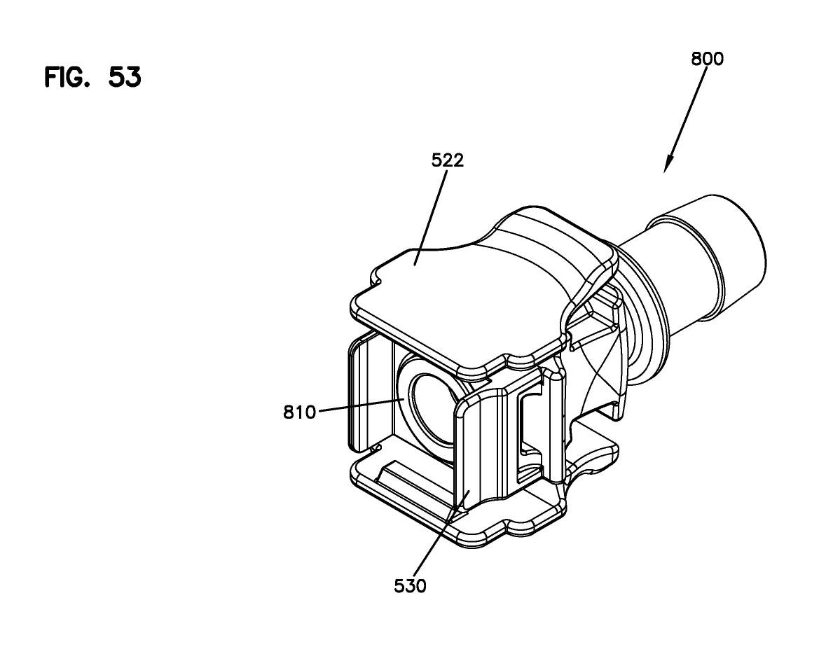

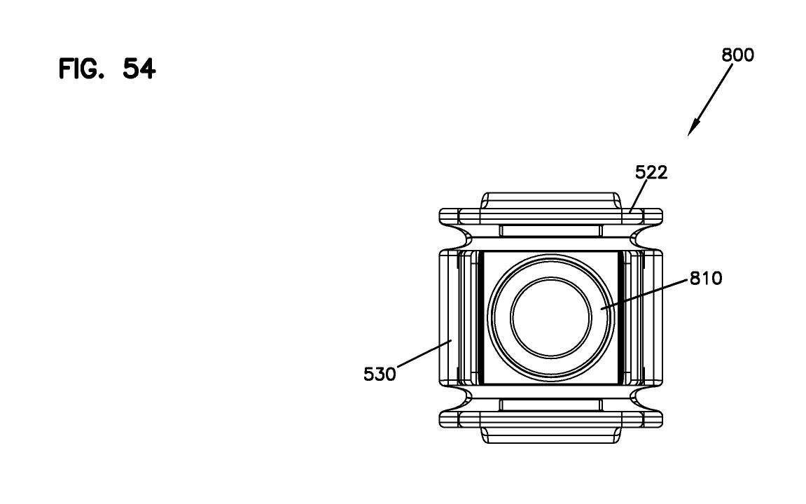

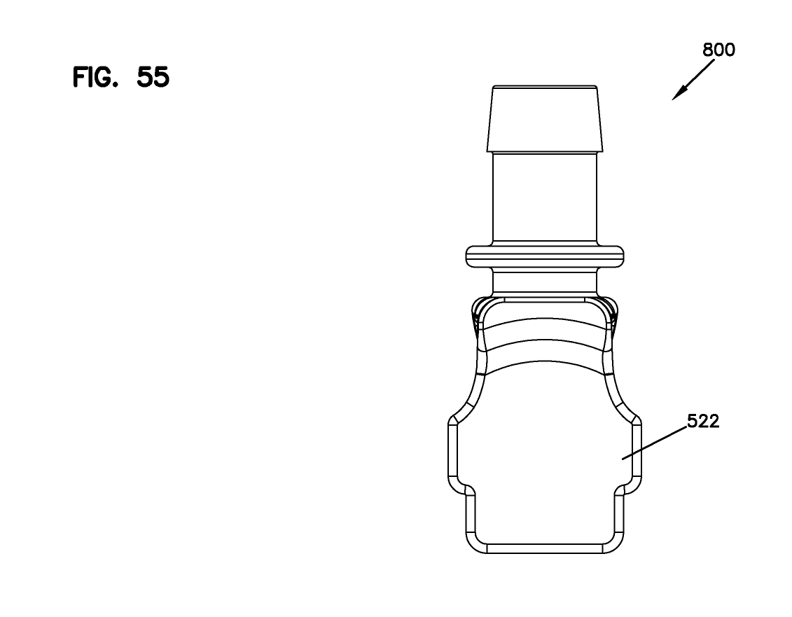

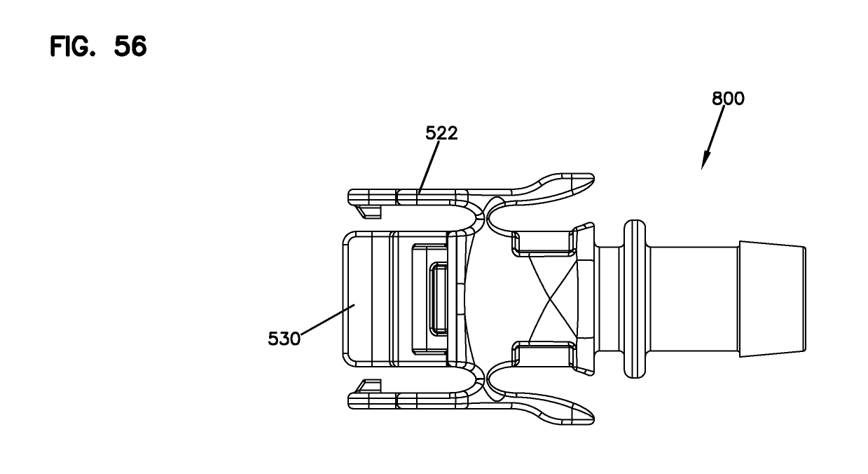

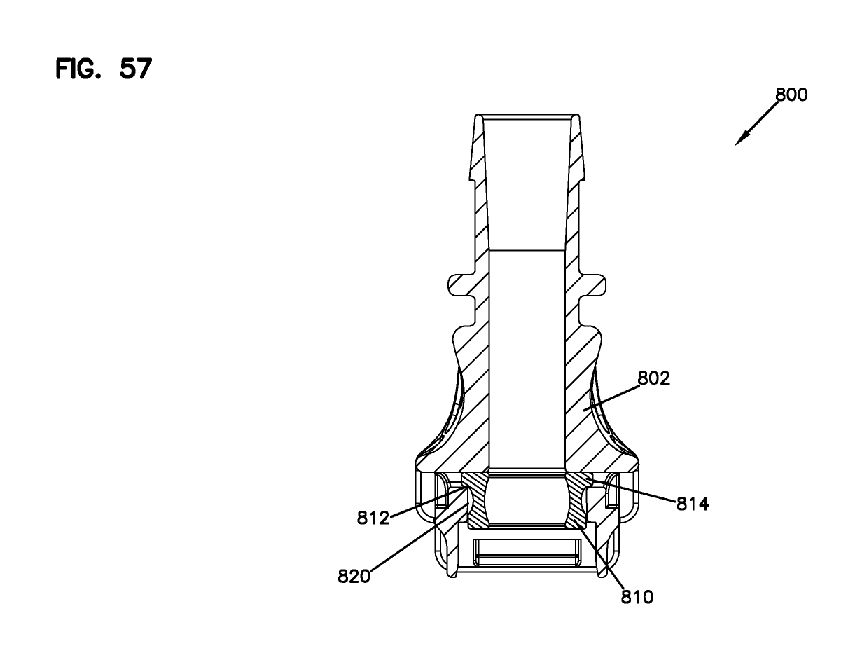

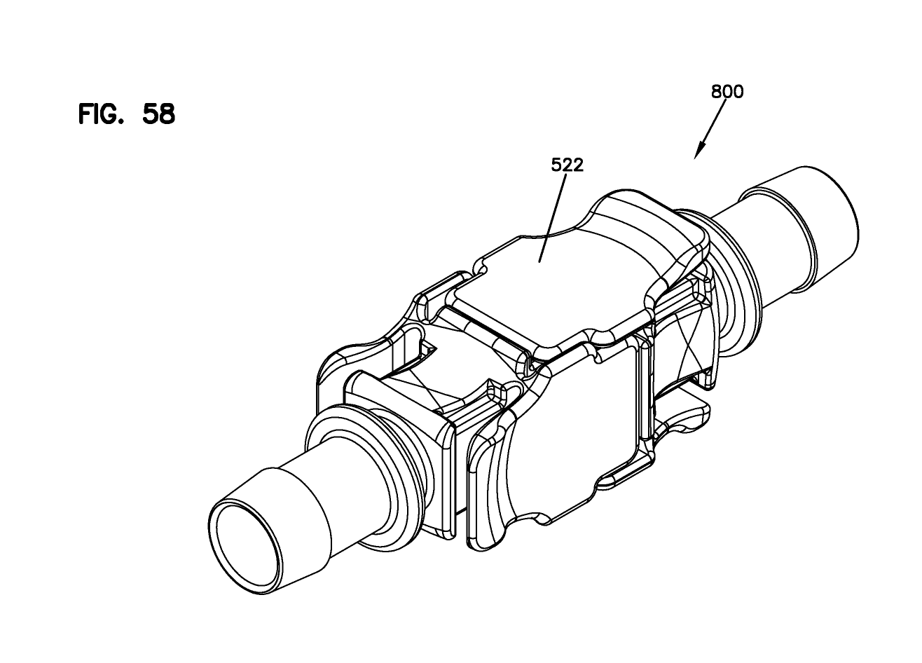

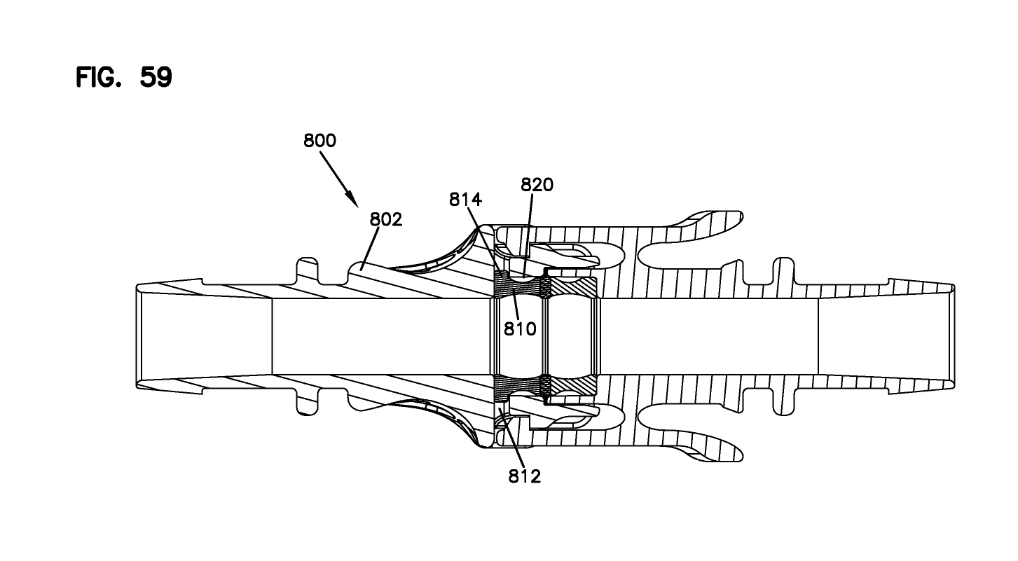

Referring now to FIGS. 53-59, another example coupling device 800 is shown. The coupling device 800 is similar to that of coupling devices 650 and 750. However, the coupling device 800 includes a sleeve 802 forming an opening 812 into which a portion 814 of the seal 810 extends. See FIGS. 57 and 59. This portion 814 of the seal 810 is captured in the opening 812 to help retain the seal 810 within a pocket 820 formed by the sleeve 802 to hold the seal 810.

In some example, multiple portions or protrusions are formed by the seal 810 to be received in one or more openings formed in the pocket of the sleeve. For example, the portions can be formed on the outer circumference of the seal. Corresponding openings can be formed in the pocket of the sleeve to receive the portions when the seal is positioned in the pocket. This allows for an enhanced interface between the seal and the pocket to retain the seal within the pocket of the sleeve.

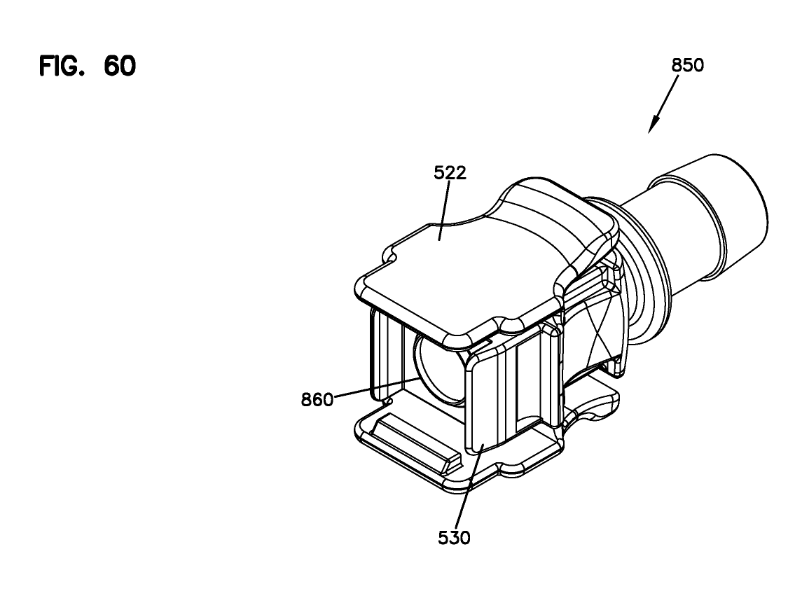

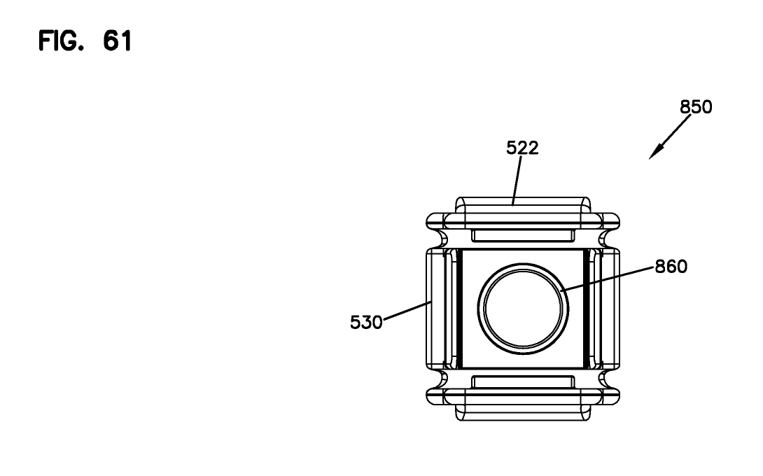

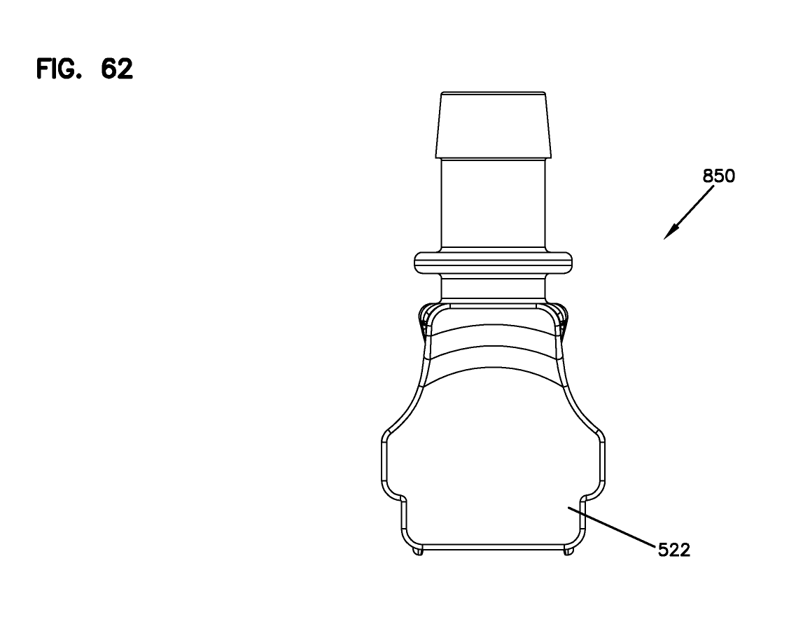

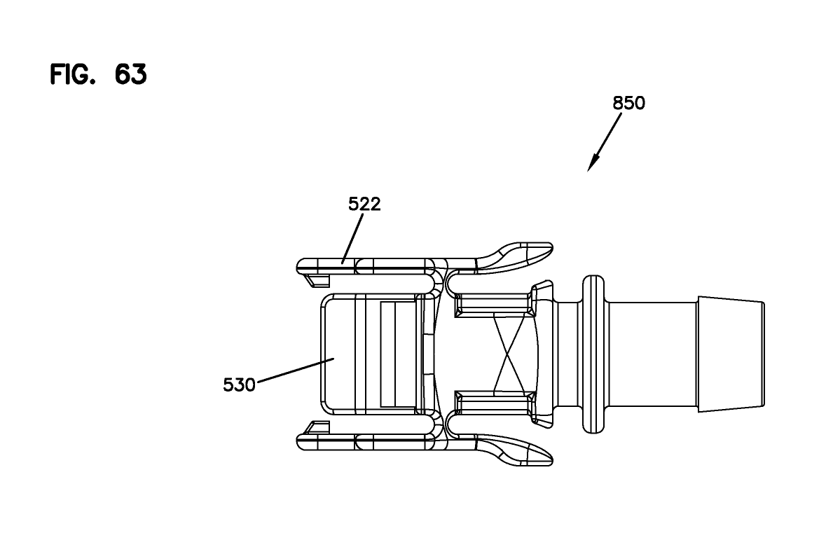

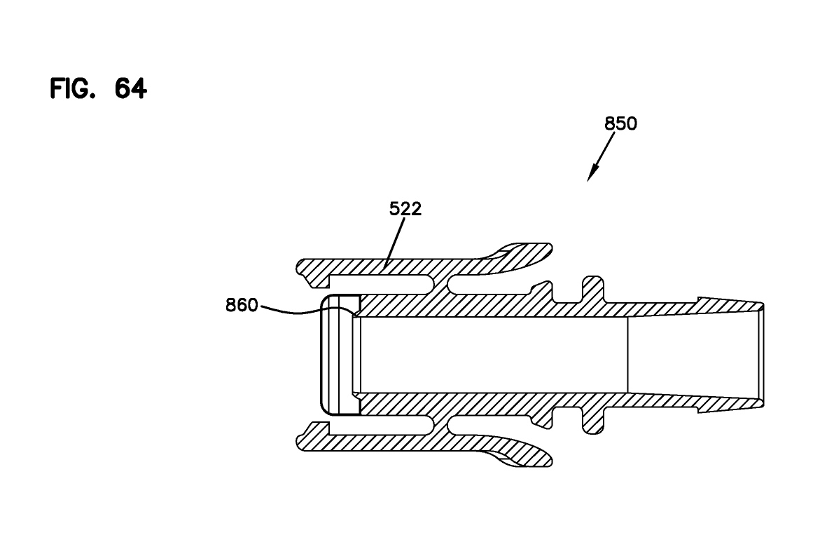

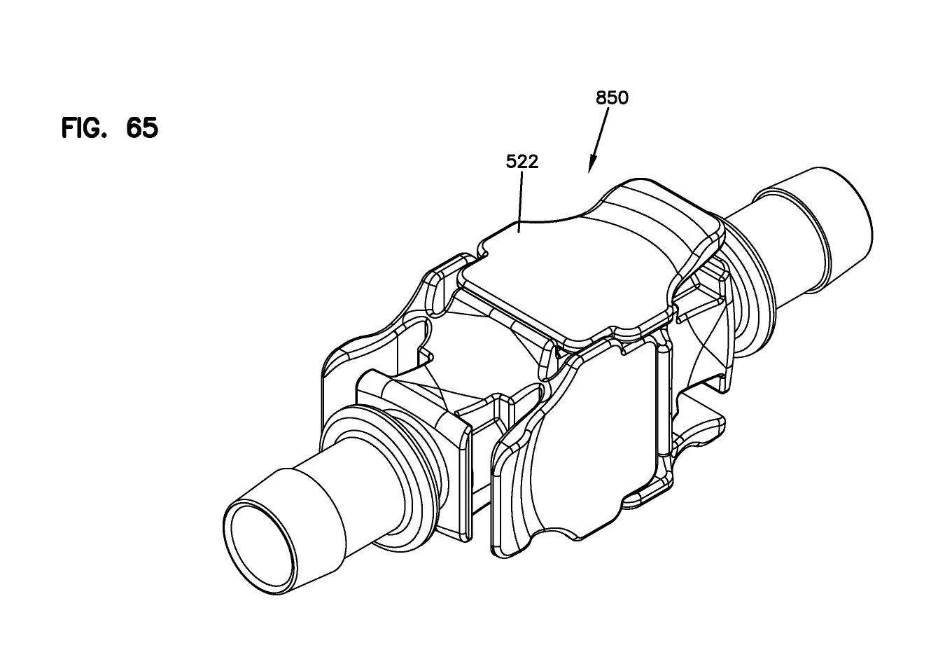

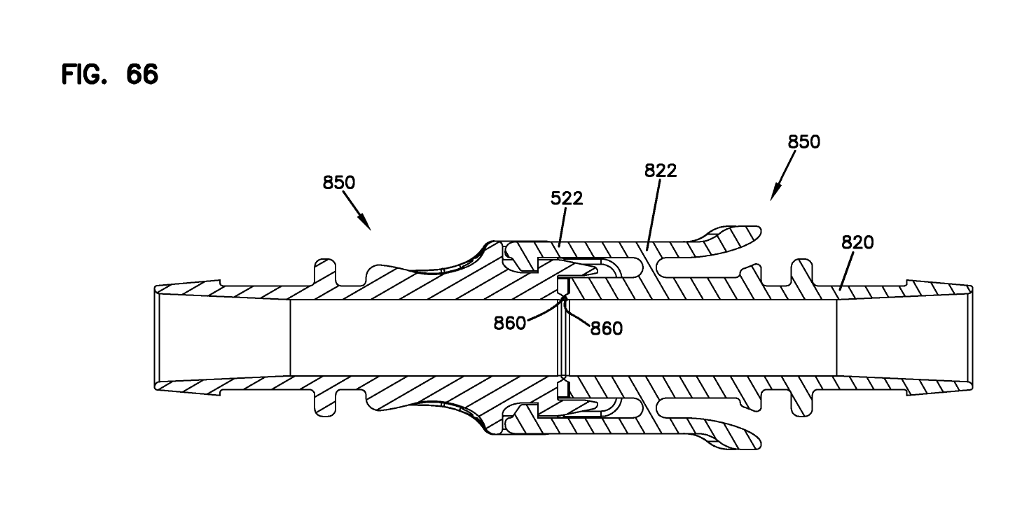

Referring now to FIGS. 60-66, another example coupling device 850 is shown. The coupling device 850 is similar to that of coupling devices 650, 750, and 800. However, the coupling device 850 does not include a separate seal. Instead, a front portion 860 of the coupling device 850 is formed of a material with a sufficient softness to engage and seal against a front portion 860 on a mating coupling device 850 of identical configuration. See FIGS. 64 and 66. In this example, an entirety of the the sleeve 822 including the front portion 860 is formed of a deformable material. When mated, the front portion 860 deforms sufficiently to form a seal with a mating coupling device 850. In some examples, the coupling device 850 is formed in whole or part of polyethylene, polypropylene, PVDF, TPE, and/or polyurethane to accomplish the sealing at the front portion 860.

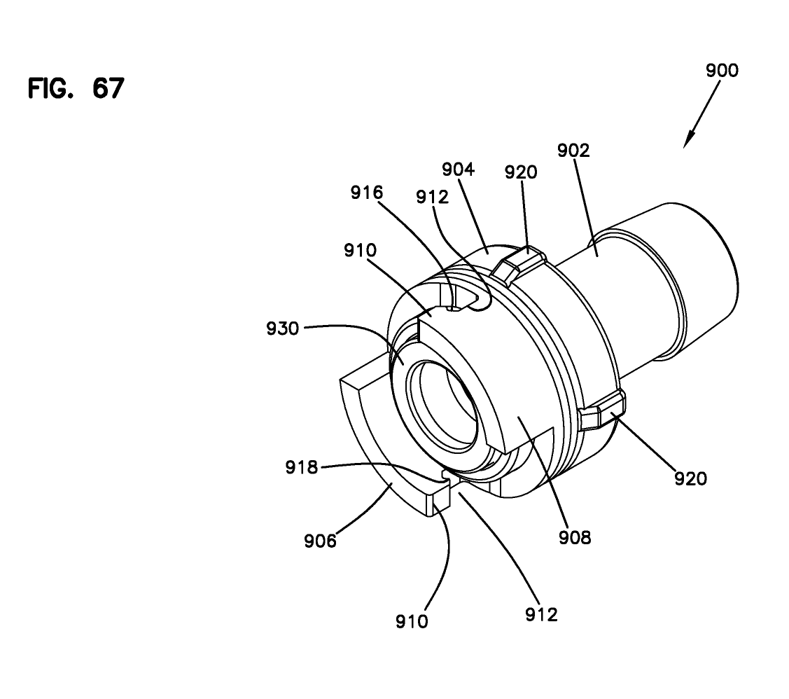

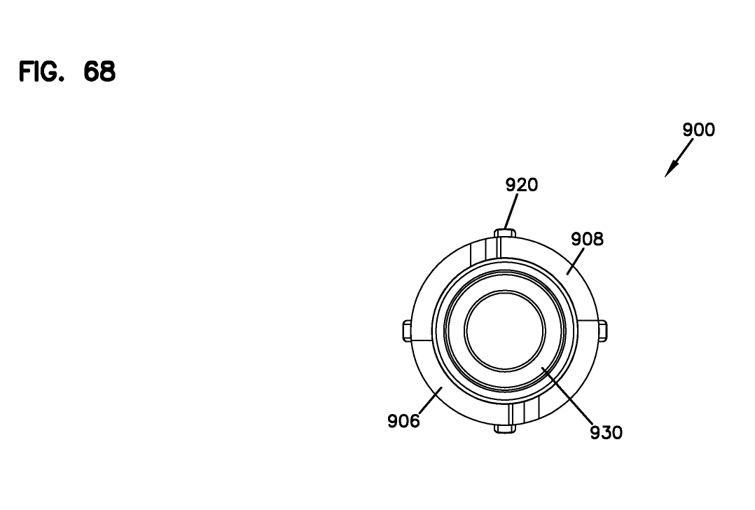

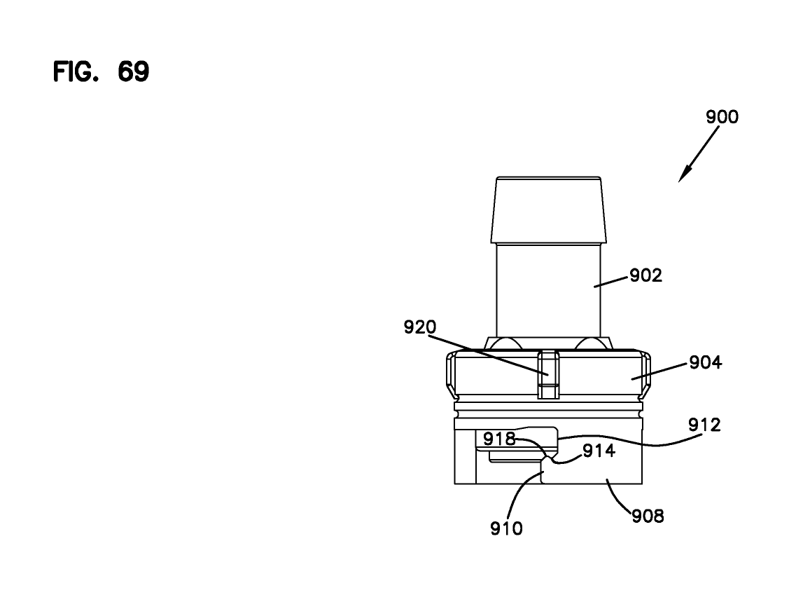

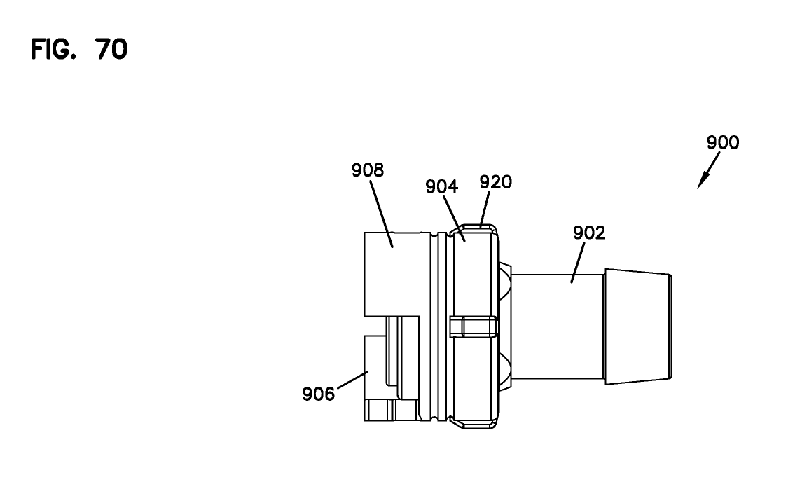

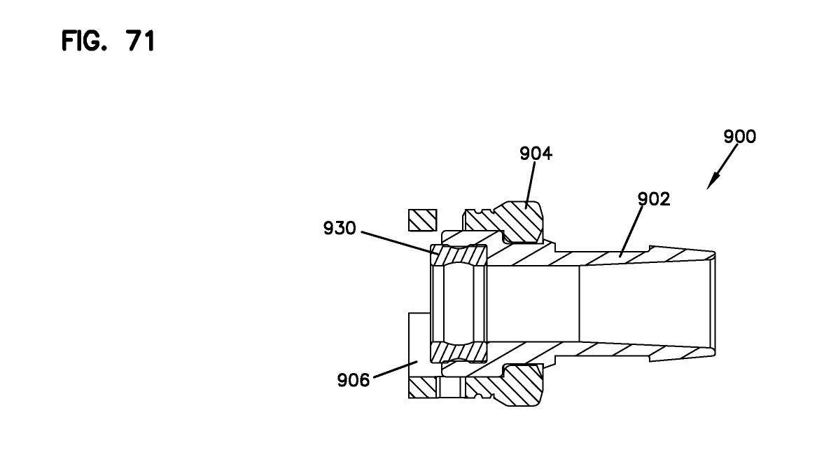

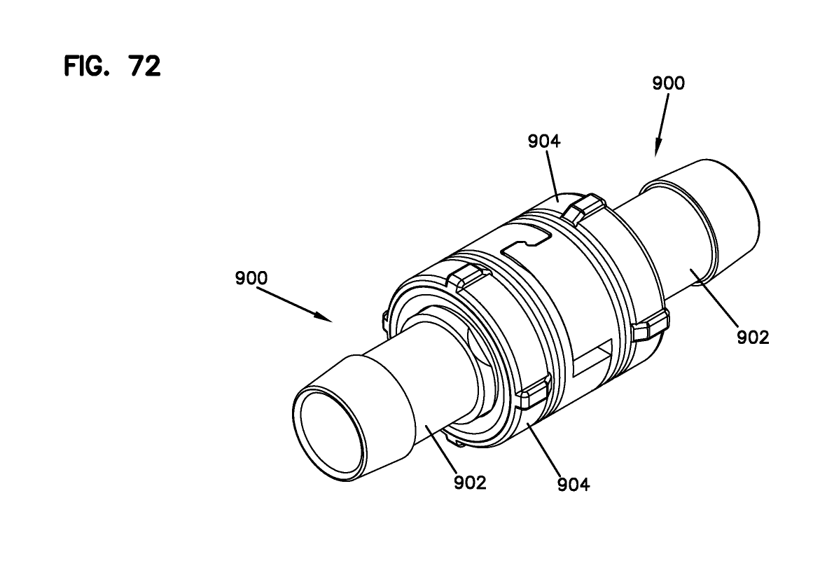

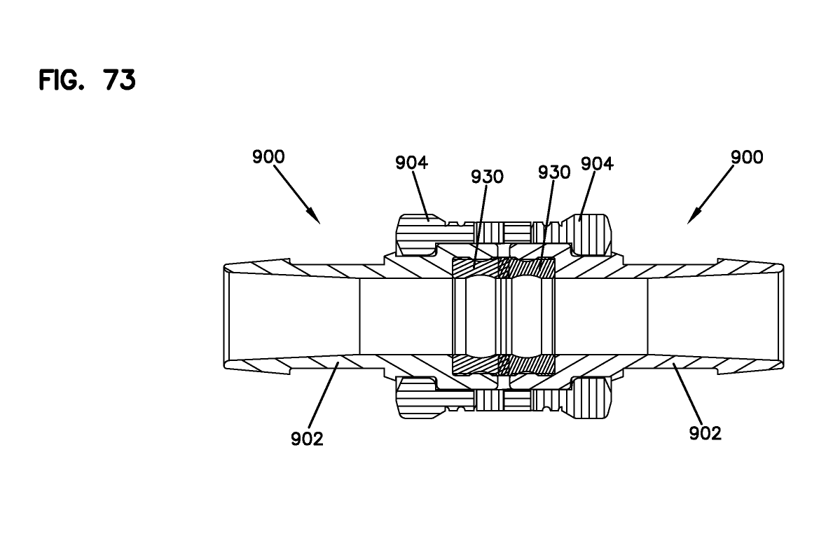

Referring now to FIG. 67-73, another example coupling device 900 is shown. In this example, the coupling device 900 includes an insert 902 and a sleeve 904 positioned thereon. The sleeve 904 rotates about the insert 902 as the coupling device 900 is coupled to an identical mating coupling device 900, as shown in FIGS. 72-73.

In this example, the sleeve 904 is circular and includes members 906, 908 extending from the sleeve 904 and forming tabs 910 and openings 912. To couple the coupling device 900 to an identical mating coupling device 900, the members 906, 908 are oriented to fit between the members 906, 908 on the mating coupling device 900. In that position, the sleeve 904 is rotated (knurled portions 920 formed on the sleeve 904 can assist the user in grasping and rotating the sleeve 904) in a first direction until the tabs 910 are received in the openings 912 of the mating coupling device 900, and vice versa. A notch 916 formed in each of the openings 912 receives a tip 918 of the mating tab 910 to lock the tab 910 within the opening 912.

In this position shown in FIGS. 72-73, the coupling device 900 is coupled to the mating coupling device 900 so that seals 930 in each of the coupling devices 900 forms a fluid-tight connection. To uncouple, the sleeve 904 is rotated in a second opposite direction until the tabs 910 clear the openings 912, which allows the coupling device 900 to be moved axially away from the mating coupling device 900 to accomplish disconnection.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A coupling assembly, comprising:
a first coupling device including:
an insert configured to be coupled to a source or a destination of a fluid;
a seal coupled to the insert to create a seal with a mating seal; and
a sleeve coupled to the insert, the sleeve including a locking structure; and
a second coupling device that is substantially identical to the first coupling device;
wherein the first coupling device is coupled to the second coupling device by rotating the second coupling device relative to the first coupling device and moving the second coupling device axially towards the first coupling device to allow the locking structure on the first coupling device to engage the locking structure on the second coupling device and the seals of the first and second coupling devices to form an axial seal so that the fluid can flow through the first and second coupling devices.

2. The coupling assembly of claim 1, wherein the second coupling device is rotated ninety degrees relative to the first coupling device.

3. The coupling assembly of claim 1, wherein the second coupling device is rotated 180 degrees relative to the first coupling device.

4. The coupling assembly of claim 1, wherein the locking structure includes opposing first members defining grooves and opposing second members including tabs, and the first coupling device is coupled to the second coupling device by allowing the tabs of the first coupling device to engage the grooves of the second coupling device.

5. The coupling assembly of claim 1, wherein the locking structure includes a tab and an opening, and the first coupling device is coupled to the second coupling device by allowing the tab of the first coupling device to engage the opening of the second coupling device.

6. The coupling assembly of claim 1, wherein the seal is molded onto the insert.

7. The coupling assembly of claim 1, wherein the seal is molded using a two-shot molding process.

8. The coupling assembly of claim 1, wherein the seal is an integral portion of the sleeve.

9. The coupling assembly of claim 1, wherein the insert and the sleeve are integral.

10. The coupling assembly of claim 1, wherein the insert is separate from the sleeve.

11. The coupling assembly of claim 1, wherein the insert rotates relative to the sleeve.

12. The coupling assembly of claim 1, wherein the insert defines a pocket to hold the sleeve.

13. The coupling assembly of claim 12, wherein the insert defines a groove sized to receive at least a portion of the seal to couple the seal to the insert within the pocket.

14. A coupling assembly, comprising:
a first coupling device including:
an insert configured to be coupled to a source or a destination of a fluid;
a sleeve coupled to the insert, the sleeve including a locking structure having opposing members and opposing grooves, and the sleeve defining a pocket; and
a seal coupled to the insert within the pocket to create a seal with a mating seal; and
a second coupling device that is substantially identical to the first coupling device;
wherein the first coupling device is coupled to the second coupling device by orienting the second coupling device ninety degrees relative to the first coupling device and moving the second coupling device axially towards the first coupling device to allow the opposing members on the first coupling device to engage the opposing grooves on the second coupling device and the seals of the first and second coupling devices to form an axial seal so that the fluid can flow through the first and second coupling devices.

15. The coupling assembly of claim 14, wherein the opposing members pivot away from one another to allow the opposing members on the first coupling device to disengage the opposing grooves on the second coupling device to uncouple the first coupling device from the second coupling device.

16. The coupling assembly of claim 14, wherein the second coupling device is rotated 180 degrees relative to the first coupling device.

17. The coupling assembly of claim 14, wherein the opposing members on the first coupling device include tabs that are received in the opposing grooves on the second coupling device.

18. The coupling assembly of claim 14, wherein the seal is molded onto the insert.

19. The coupling assembly of claim 14, wherein the seal has an hourglass shape.

20. A coupling assembly, comprising:
a first coupling device including:
an insert configured to be coupled to a source or a destination of a fluid;
a sleeve coupled to the insert, the sleeve including a locking structure having opposing members and opposing grooves, and the sleeve defining a pocket; and
a seal coupled to the insert within the pocket to create a seal with a mating seal, wherein the seal has an hourglass shape; and
a second coupling device that is substantially identical to the first coupling device;
wherein the first coupling device is coupled to the second coupling device by orienting the second coupling device ninety degrees relative to the first coupling device and moving the second coupling device axially towards the first coupling device to allow the opposing members on the first coupling device to engage the opposing grooves on the second coupling device and the seals of the first and second coupling devices to form an axial seal so that the fluid can flow through the first and second coupling devices; and
wherein the opposing members pivot away from one another to allow the opposing members on the first coupling device to disengage the opposing grooves on the second coupling device to uncouple the first coupling device from the second coupling device.
